(19) United States
(12) Patent Application Publication
(10) Pub. No.: US 2003/0196542 A1
(43) Pub. Date: Oct. 23, 2003

(54) Guitar effects control system, method and devices

(76) Inventor: Shelton E. Harrison JR., Los Angeles, CA (US)

Correspondence Address: SHELTON E. HARRISON, JR., 6643 POPLAR PIKE, MEMPHIS, TN, 38119, US

(21) Appl. No.: 10/414,967

(22) Filed: Apr. 16, 2003

Related U.S. Application Data
(60) Provisional application No. 60/372,974, filed on Apr. 16, 2002.

(51) Int. Cl. G10H 1/02

(52) U.S. Cl. 84/737

(57) ABSTRACT

Disclosed is a guitar effects controller comprising a digital compass and means for converting directional degree information to signal effect level values. Alternate embodiments provide different sensors, e.g., GPS receiver or tilt sensor. The invention allows user control of instrument volume or other signal effects by turning, tilting, or otherwise manipulating the guitar. Also disclosed is a user configuration system whereby an effects controller can be configured using RF or infrared technology, RFID tags, the Internet, and other tools. Controller function is enhanced by a multipurpose guitar docking station and case. Also disclosed is a universal music exchange medium to facilitate the rapid configuration of system components.

### CROSS REFERENCE TO RELATED APPLICATIONS

Priority filing of U.S. provisional patent application No. 60/372,974, filed Apr. 16, 2002, is claimed. Said provisional patent application is hereby incorporated by reference in its entirety into the present disclosure.

A portion of the disclosure of this patent document contains material which is subject to copyright protection. The copyright owner has no objection to the facsimile reproduction by anyone of the patent documents or patent disclosure, as it appears in the patent trademark office patent file or records, but otherwise reserves all rights whatsoever. STATEMENT REGARDING FEDERALLY SPONSORED RESEARCH AND DEVELOPMENT

None.

### REFERENCE TO SEQUENCE LISTING, A TABLE, OR A COMPUTER PROGRAM LISTING APPENDIX

None.

### BACKGROUND OF THE INVENTION

1. Field of the Invention

The present invention relates to musical instruments and accessories, signal effects processors, and the dissemination of music-related information.

2. Description of Related Art

Ideally, electric guitar players would not have to stand next to an effects pedal board in order to control guitar effects. Guitarists typically are not interested in having “brilliant ankles.”

Marinic, U.S. Pat. No. 6,242,682, teaches a guitar-mountable digital control for an analog signal, as does Burke, U.S. Pat. No. 5,866,834. Wheaton, U.S. Pat. No. 5,541,358, teaches a position-sensing controller for electronic musical instruments. Seli, U.S. Pat. No. 6,441,294, provides a guitar strap for affecting a signal. Feedback has also commonly been used to affect a signal without the use of foot pedals, such as the device in Menning, U.S. Pat. No. 5,449,858.

Other noteworthy offerings include: the MIDI shoe, created by IBM in collaboration with MIT, which is a mechanism to record the movements of a dancer's feet; the gesture interface in Okamoto, U.S. Pat. No. 5,648,626; Tokioka, U.S. Pat. No. 5,714,698; and Longo, U.S. Pat. No. 6,066,794; user configurations of mapping routines for such a gesture interface, Leh, U.S. Pat. No. 6,388,183; the “interactive playground” in U.S. Pat. No. 5,990,880 to Huffman et al; a musical glove, Masubuchi, U.S. Pat. No. 5,338,891; and the position-sensing wand in Marrin, U.S. Pat. No. 5,875,257. Many of these devices, such as the MIDI shoe and other novelties, seem primarily geared toward amusing academicians and technophiles. Actual musicians have little need for a MIDI shoe, an electronic baton, a glove, a gesture interface, or an interactive playground.

Other offerings appear that they would be effective at what they are intended to do but have significant limitations.

For instance, Wheaton, '358, perhaps the most relevant to the present invention, suffers from complexity that the present invention avoids through the use of, inter alia, a magnetic compass and GPS receiver. Leh, '183, relevant in that it discloses a method of user configuration, also suffers from a number of limitations: like other MIDI devices mentioned above, a “virtual musical instrument” or “gesture interface” holds little practical value for working musicians. Leh also fails to provide the comprehensive system of user interfaces, data exchange mechanisms, etc., that enable meaningful deployment of the present invention.

In short, controller devices do not exist in a vacuum. In order to be effectively incorporated into a performance, a controller must be in a form that is useful to musicians playing instruments that are played in basically the same way as they were prior to the advent of electronic music, e.g., the guitar, piano, trumpet, etc., for even the major electronic instruments, namely, the electric guitar and the MIDI keyboard, are played almost exactly like a standard acoustic guitar and a standard acoustic piano. This reality is not likely to change soon. Moreover, there must be an entire system of support and interactivity into which the given controller device fits. Such a form and such a system are absent from the above teachings.

What is needed therefore is a comprehensive system, method and device that allows a working musician playing a traditional, stringed instrument to control signal effects without having to use foot pedals or other inconvenient interfaces.

A shortcoming of conventional signal effects processors, e.g., the Boss ME-5, and the above alternative instruments and controllers lies not with their usage during performance but rather the difficulty a typical user or sound engineer encounters when trying to configure these devices prior to performance. What is needed therefore is a system, method and device that allows music technology users to configure devices more easily and effectively.

A common shortcoming of instrument-mounted signal effect devices in particular is that these mechanisms cannot be manipulated by a sound engineer, who may be dozens of meters away from the instrument. What is needed therefore is a mechanism that brings instrument-mounted controllers under the control of a remote engineer, even in an environment containing several identical instruments and controllers.

Another obstacle typically faced by working musicians is the necessity of maintaining and transporting a large quantity of equipment. What is needed therefore is an instrument stand and an instrument carrying case that serve multiple purposes, thereby minimizing the number of objects needed for a gig.

Another shortcoming of sensor-based controllers and instruments is the lack of an effective monitoring system whereby a musician can gather real-time information regarding sensory and control data currently being output.

What is needed therefore is an improved monitoring system that not only informs the performer of the sound being produced but also of the particular control data value that went into making that sound.

More and more electronic instruments are including active pickups, and the present invention typically requires a power source mounted in or on the instrument. Therefore, a novel guitar and novel guitar docking station that provides a power source for recharging electric guitar components is also provided herein.

Typical signal effects processors and level or amplitude controls, such as a volume pedal, provide a set range of motion and do not allow a user to customize this range of motion or “mute” or constrain certain potential value ranges. What is needed therefore is a mechanism that not only brings signal effects under the control of the user but also brings the criteria used to generate those signal effects under the control of the user. Moreover, a mechanism of memorizing, wirelessly transferring, and uploading and downloading via Internet such user-defined configuration settings for different contexts, sensors, effects, and musical compositions is disclosed.

Another shortcoming of typical musical control devices is that one controller will control one variable and another controller will control another variable. What is not taught in other literature, however, is the process of combining control data of two unrelated controllers such that the combination of this data serves to control a third variable.

Another obstacle faced by most working musicians is the financial impracticality of hiring a light show crew. What is needed therefore is a controller that allows a working musician to run his or her own light show while performing. A prior effort at such a device appears in Kim, U.S. Pat. No. 4,563,933.

Typically, sheet music and digital files pertaining to a musical composition, such as a MIDI rendering or sound recording thereof, are reproduced on separate media, and often times even distributed separately. Yet both of these information sources can be useful for preparation and performance of the given piece. Moreover, there is no standardized way to import all information—from musical to legal—pertaining to a composition into a database directly from a piece of printed sheet music. What is needed therefore is a system, method and device that allows for comprehensive digital information to be distributed in a standardized format directly through sheet music.

Finally, the related art does not teach a system or method whereby data pertaining to virtually all aspects of the music industry—the musicians, the compositions, the technology, the legal rights—can be freely stored, exchanged and accessed in a single common format. Nor does the related art teach a system and method whereby specification data can be carried in a structured form on musical objects themselves, such as instruments and equipment, so that no external source of information is needed. What is needed therefore is a universal music exchange medium.

b. Other Related Art Used in the Current Invention

Among the environmental sensors available for use in the present invention are: a digital compass, such as that used in the HMR 3100 from Honeywell, www.honeywell.com or the PDC803 digital compass from Smart Home, which output digital directional degree information (e.g., “235°”); a gyroscopic angular velocity sensor with analog/digital converter such as that used in Inanaga, U.S. Pat. No. 5,844,816; a digital tilt sensor, such as that used in the EL tiltmeter from Durham Geo-Enterprises, www.slopeindicator.com; the digital scale, such as that used in the Ohaus HP-120; and a digital distance meter, such as that used in the Bosch DLE30 Plus.

Barcodes and particularly the 2D (two-dimensional) printed codes used in the present invention, which are capable of encoding hundreds of times more data per unit area than traditional one-dimensional barcodes, and scanners for scanning and decoding information encoded therein are available from companies such as Symbol, www.symbol.com (e.g., PDF 417 symbology). RFID tags, etc., are available from companies such as Alien Technology.

All publications available for public download or viewing via the World Wide Web on or prior to the date of this filing are hereby incorporated by reference in their entirety into the present disclosure.

A primary object, therefore, of the present invention is to provide a mechanism that is easier to use to control instrument volume and other signal-processing effects than the conventional foot pedals, buttons, dials and faders commonly used for this purpose. In particular, the preferred embodiment provides a compass, mounted on the musician's instrument or the musician's person and equipped to output controller information that can be manipulated in real-time by the musician during an actual musical performance simply by controller position change. Other environmental sensors can be used somewhat interchangeably or in combination with one another.

### BRIEF SUMMARY OF THE INVENTION

The invention allows user control of instrument volume or other signal effects by turning, tilting, or otherwise manipulating the guitar. Such control is made possible by a digital compass, GPS receiver, tilt sensor or other sensor and the disclosed methods of converting sensory data into guitar signal effect level values.

A variety of novel user configuration tools are also provided wherein such technologies as RF or infrared data exchange, RFID tags, encoded symbols, and the Internet are deployed.

Controller function is enhanced by a multipurpose guitar docking station that provides a mechanism by which internal components of a guitar can be recharged simply by plugging into the guitar docking station, which also provides a power strip and patchbay.

A stageshow case configured to perform visual or other functions in response to sensory data transmissions is also disclosed.

Also disclosed is a universal music exchange medium, whereby the field of music is divided into domains and features, and then characteristics of these features are treated as data objects. Data is then recorded in a document and encoded; a code symbol is distributed on virtually all musical items; decoded when the data is needed; and the data retrieved therefrom used.

### BRIEF DESCRIPTION OF THE DRAWINGS

FIG. 1 depicts a flowchart illustrating the general process by which signal effects are controlled in the present invention.

FIG. 2 depicts a chart of some of the different environmental sensors that can be used in controlling signal effects according to the present invention.

FIG. 3 depicts a chart of some of the different musical instruments and accessories that can be used in creating the signal that is modified by an effects processor in the present invention.

FIG. 4 depicts a chart of some of the different signal effects that can be applied to instrument signals.

FIG. 5 depicts a chart of some of the devices that can be used to configure a controller device, as well as various data exchange mechanisms by which such configuration can be accomplished.

FIG. 6 depicts a chart of some of the input and output methods and mechanisms that can be used in configuration of devices in the present invention.

FIG. 7 depicts a chart of some of the mechanisms by which a controller device can be attached to a musical instrument or a musician's body.

FIG. 8 depicts a chart illustrating the flow of data through the various parts of the system disclosed herein.

FIG. 9 depicts a schematic diagram of the essential components of a controller, an external configuration device, and a remote computer, including the mechanisms by which data exchange links can be established between these components and other devices.

FIG. 10 depicts an anterior view of a controller device according to the present invention.

FIG. 11 depicts a schematic diagram of the relationship between a controller and a PDA equipped for line-of-sight data exchange.

FIG. 12A depicts a schematic diagram of a system including three different controllers and a sound mixing board equipped for wireless data exchange that does not require a line of sight between the transmitter and the receiver. FIG. 12B depicts an example of the information transmitted in a system such as that depicted in FIG. 12A.

FIG. 13A depicts a perspective view of a controller device which can be configured using manually operable buttons included thereon, without the use of an external configuration device, and which also includes a port for a cable through which a signal can be transmitted.

FIG. 13B depicts a perspective view of a guitar upon which a controller according to the present invention has been mounted in two alternate locations.

FIG. 13C depicts a configuration device that is a key palette equipped with manually operable buttons.

FIG. 14 depicts a musician holding a guitar upon which a controller according to the present invention is mounted; superimposed is a circle demonstrating the potential compass headings (e.g., north, sound, east, west) that this musician can face, noting the current directional degree of the controller in its depicted position.

FIG. 15 depicts a flowchart illustrating a process by which a compass heading in compass degrees or any numerical values derived from an environmental sensor can be converted to signal effects levels.

FIG. 16 depicts an example of a conversion of a compass degree value to a signal effect level value by way of an algorithm according to the present invention.

FIG. 17 depicts the data relationship between databases in the memory (RAM/ROM) of a controller device and a configuration device.

FIG. 18 depicts a sample or “screenshot” of the visual output of a flat-panel display mounted on a configuration device used in the current invention, whereby the current settings of multiple controller devices can be simultaneously monitored by a remote sound engineer.

FIG. 19 depicts a sample or “screenshot” of the visual output of a flat-panel display mounted on a configuration device used in the current invention, including the contents of various fields in a “scene” database record, a scene being a stored set of mapping routines and other user-defined configuration settings to be stored and used together.

FIG. 20 depicts a sample or “screenshot” of the visual output of a flat-panel display mounted on a controller device according to the current invention, including the current configuration settings of this controller device.

FIG. 21 depicts a sample or “screenshot” of the visual output of a flat-panel display mounted on a signal effects processor device used in the current invention, including the current settings of this signal effects processor.

FIG. 22 depicts a guitar player holding a guitar equipped with a tilt sensor at a particular angle. FIG. 23 depicts the guitarist holding the guitar at a different angle.

FIG. 24 depicts an example of a process by which a tilt sensor value is converted to an effect level value.

FIG. 25 depicts a guitar equipped with two alternate mountings for a digital distance meter-equipped controller.

FIGS. 26 and 27 depict a controller equipped with a digital distance meter in use.

FIG. 28 depicts zones pertaining to GPS coordinates received by a controller device.

FIG. 29 depicts the process by which sensory values are used to increase or decrease effect level values incrementally.

FIG. 30 depicts an example of a sensory value being used to alter an effect level value incrementally.

FIG. 31 depicts an example of the use of GPS coordinates to produce an effect level value.

FIG. 32 depicts a guitar equipped with a digital scale/pressure meter positioned so as to contact the user's abdomen.

FIG. 33 depicts the process by which the detection of acceleration is used to prompt an event.

FIG. 34 depicts a guitarist using a video monitor system for use with a controller device equipped with an environmental sensor.

FIG. 35 depicts a guitar equipped with a fader positioned so as to contact the user's abdomen.

FIGS. 36 and 37 depict a pendulum that can be attached to a pre-existing volume control knob.

FIG. 38 depicts a posterior view of a signal effects processor for use in the present invention.

FIG. 39 depicts an example of a sensory value being converted to a MIDI value according to the present invention.

FIG. 40 depicts a guitar case equipped with a video display and other electronic features.

FIGS. 41A through 41E depict examples of the processes and uses to which the disclosed stageshow case can be put.

FIGS. 42 and 43 depict a video monitor that can be movably attached to a guitar to monitor the output of a stageshow case.

FIGS. 44 and 45 depict a guitar docking station.

FIG. 46A depicts a chart of some of the devices which can be connected for data exchange with the guitar docking station.

FIG. 46B depicts a guitar docking station after the footpedal board has been deployed.

FIGS. 48A and 48B depict a strap attachment peg equipped with a socket to be mounted on a guitar so as to dock with the guitar docking station.

FIG. 49 depicts a guitar in the guitar docking station wherein a power cable has been inserted into the peg/socket of the guitar so as to enable the charging of internal guitar components.

FIG. 50 depicts a flowchart illustrating the process by which a universal music exchange medium (“UMEM”) is created; data pertaining to characteristics of a musical item or person is recorded in a document and encoded; a code symbol is distributed and decoded; and the data retrieved therefrom used.

FIG. 51 depicts a chart of some musical domains.

FIG. 52 depicts a breakdown of some features of a particular domain, namely, that of a composition.

FIG. 53 depicts some individual characteristics pertaining to a particular feature of a particular domain, namely, the legal parameters pertaining to a composition.

FIG. 54 depicts a piece of sheet music containing both human-readable symbols and encoded symbols.

FIG. 55 depicts an excerpt from the document encoded in the symbols in FIG. 54.

FIG. 56 depicts a guitar which bears an encoded symbol.

FIG. 57 depicts an excerpt from the document encoded in the symbols in FIG. 56.

FIG. 58 depicts a musician ID card bearing an encoded symbol.

FIG. 59 depicts an excerpt from the document encoded in the symbols in FIG. 58.

FIG. 60 depicts a mixing board configured to access information encoded in symbols appearing on a wide variety of music-related items in the environment by way of a scanner.

FIG. 61 depicts a schematic diagram of the process by which a UMEM-encoded document is transferred and used in conjunction with a guitar docking station.

FIG. 62 depicts a controller equipped with page-turn buttons.

FIG. 63 depicts a flowchart illustrating the process by which multiple UMEM-encoded documents are distributed, accessed and used to facilitate the work of a sound engineer.

### DETAILED DESCRIPTION OF THE INVENTION WITH REFERENCE TO THE DRAWINGS

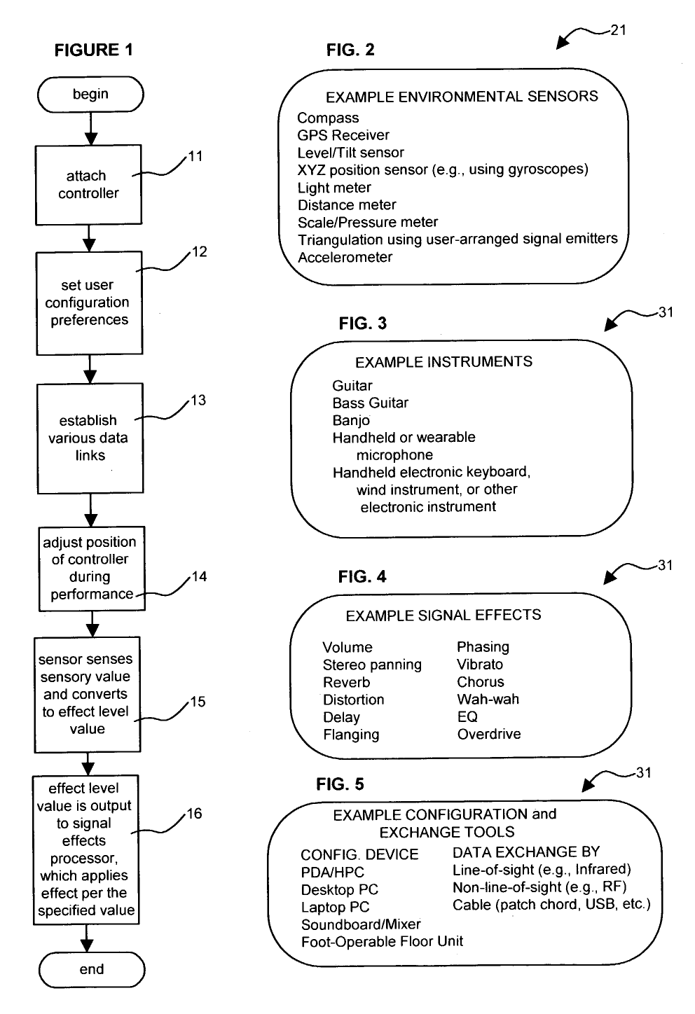

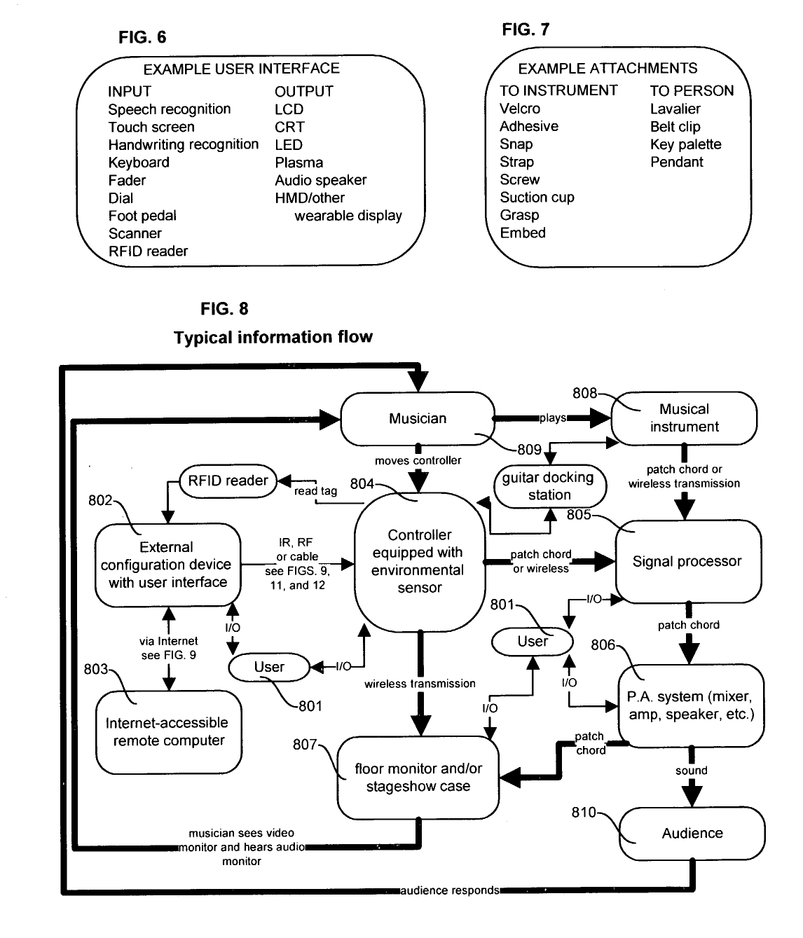

FIG. 1 presents an overview of the process used in the current invention to allow a musician to control signal effects during performance simply by moving his instrument or body. First, a controller device including an environmental sensor (see FIG. 2) is attached to the person's body or instrument (see FIG. 3) using an attachment mechanism (see FIG. 7) 11. Then the musician or an assistant configures the controller device 12. Such configuration can be made either through an external configuration device (see FIG. 5) by way of a data exchange mechanism (see FIG. 5) or through direct interface with the controller device itself. Regardless of which configuration approach is taken, a wide variety of user interfaces can be used for such configuration (see FIG. 6).

Next, remaining data links between the components of the disclosed system as a whole are established 13 so as to enable the information flow depicted in FIG. 8. Each of these first three steps can be performed in any order with respect to each other and can be repeated as necessary during the course of a performance.

Next, once the setup steps have been completed, the musician can control the output of new signal effect level information simply by adjusting the position of the controller during performance 14. If the controller has been attached to or embedded in the musician's instrument, this adjustment is made by moving the instrument. If the controller has been attached to the musician's person, this adjustment is made by body movement.

When the environmental sensor included in the controller device senses a new sensory value, this value is converted to a new effect level value 15 according to a process such as that depicted in FIG. 16. The new effect level value is then output to a signal effects processor, thereby adjusting the level of the given effect being applied to the given instrument signal 16.

FIG. 8 depicts the typical flow of information according to the present invention. Clearly, different forms of data transmission can be used as substitutes for those expressly stated in the diagram and certain data flows occur only once while others recur continually throughout a performance. Thick arrows represent data flows that typically recur during performance.

Typically, a person 801 accesses a configuration device 802, which may be in communication with a remote computer 803 by way of the Internet. Information, such as scene profile records (discussed below, see, e.g., FIGS. 17 and 19), can be downloaded from the remote computer 803 to the local configuration device 802.

Configuration information is then transferred from the configuration device 802 to the controller 804. A person 801 also configures the signal processor 805, P.A. system 806, and monitor system and/or stageshow case 807 so as to enable these devices to receive information from the controller 804 and the instrument 808 to be used.

During performance, the musician 809 plays the musical instrument 808, and the electronic analog signal produced by the pickups in this instrument 808 is conveyed to the signal processor 805. Meanwhile, the musician manipulates the position of the controller 804, and the new effect level information produced by this controller 804 is conveyed to the signal processor 805 as well as to the floor monitor and/or stageshow case 807. The signal processor 805 applies a signal effect (such as one of those depicted in FIG. 4) to the electronic signal of the instrument 808 at the level determined by the effect level value output by the controller 804. The resulting modified instrument signal is then conveyed to the P.A. system 806 such that sound is produced for the audience 810.

The musician 809 can view the floor video display 807 to see exactly what sensory data (e.g., compass degree reading) is being sensed by the controller 804 at a given moment in time. This feature allows the musician greater command than an aural monitor alone, allowing the musician to associate a sensory value with a particular sound. This floor monitor and/or stageshow case 807 also includes, however, an audio speaker with a feed from the P.A. system 806 as in the case of conventional floor monitors.

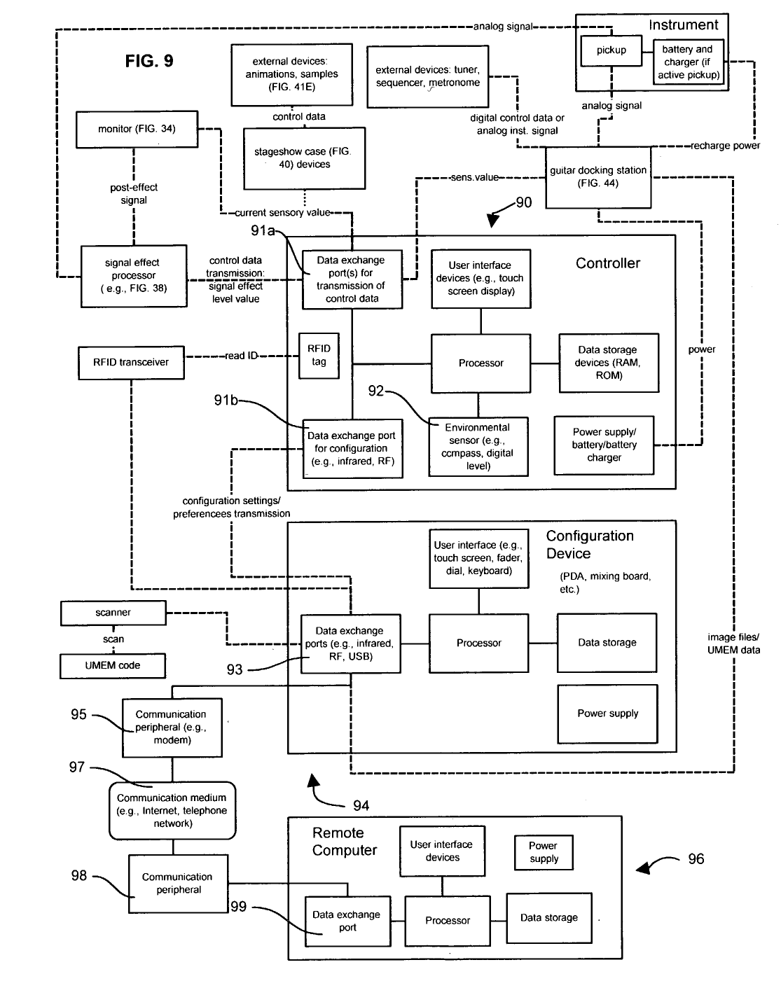

FIG. 9 depicts schematically the basic internal components of the controller device 90, the external configuration device 94, and the remote computer 96, as well as the basic links used to establish data exchange and/or power links between these devices and the others described herein.

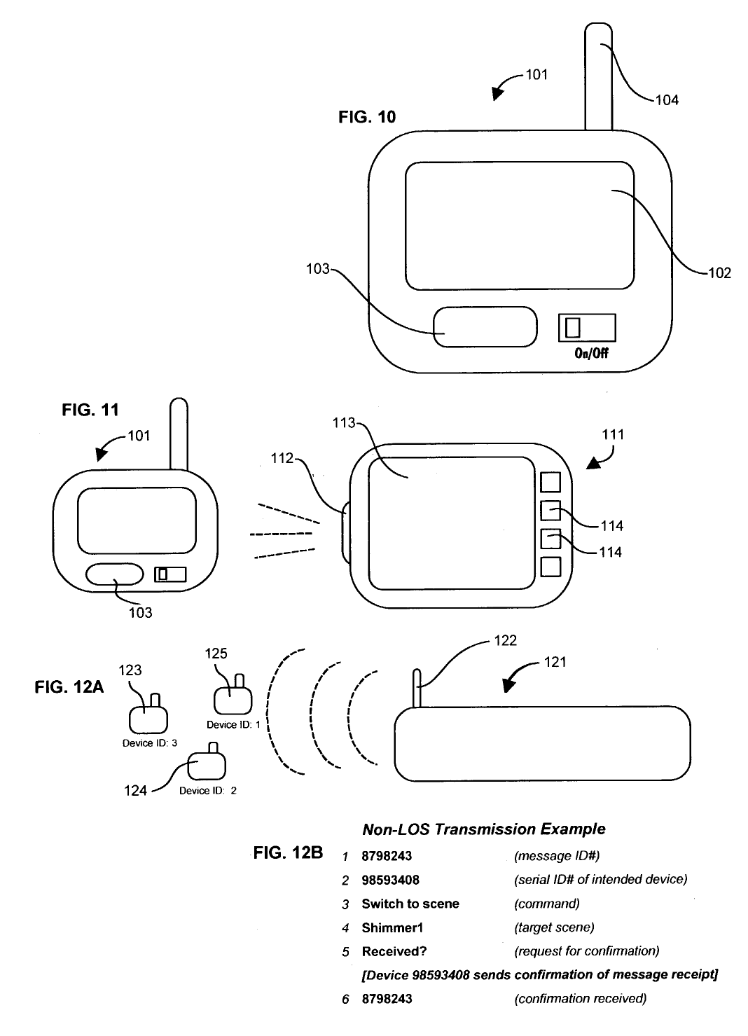

FIG. 10 depicts a controller device 101 according to the present invention. Included in this device 101 are a flat-panel display 102, an infrared port 103, and an antenna 104 for use in RF communications. This device 101 also includes the internal components depicted within the controller device 90 in FIG. 9.

FIG. 11 depicts the controller device 101 from FIG. 10 receiving information, such as a scene profile record, from a configuration device that is a hand-held PDA (personal digital assistant) 111 by way of infrared beam. As in the case of a Palm PDA from Palm Computing, the depicted PDA 111 includes an infrared port 112, touch screen 113 for the input and output of information, and some manually operable buttons 114. It also includes the internal components depicted within the configuration device 94 in FIG. 9.

FIG. 12A depicts several controller devices 123-125, each of which is essentially identical to the controller device 101 depicted in FIG. 10. Also shown is a configuration device that is a mixing board 121 that includes an antenna 122 for use in RF communications.

The transmission of configuration information from the configuration device 111 to the controller device 101 in FIG. 11 is by way of line-of-sight technology. Meanwhile, the transmission of configuration information from the configuration device 121 to the controller devices 123-125 in FIG. 12A is by way of non-line-of-sight technology. Both of these approaches have strengths and weaknesses as follows.

Sound engineers working in real-world environments, such as a nightclub or a concert venue, are constantly required to work with new kinds of equipment. Each musician or band typically brings its own instruments and an assortment of preferred accessories to a gig. The sound engineer may or may not have ever worked with a particular instrument or accessory and may or may not have an opportunity to speak with the musician who owns it. Thus, it is important to have an interface technology that allows a sound engineer to configure a controller device that he has never handled before and has but a short period of time to configure.

The limitations of line-of-sight data exchange technology are useful in such an anonymous environment. Specifically, infrared data exchange technology used in common PDAs, for instance, has a very limited range and requires essentially an unobstructed line-of-sight between the transmitting unit and the receiving unit. These limitations make it easy to physically isolate a single controller and transmit configuration data to that controller without accidentally transmitting the same data to another controller device for which said data is not intended.

Meanwhile, many sound engineers work with the same act repeatedly and therefore do not have to cope with essentially anonymous musical equipment. In such cases, the sound engineer is in a position to have particular, unique identification information pertaining to each controller device with which he works. Thus, unique identification information can be used instead of physical isolation to allow distinction between a transmission intended for one device and not another.

The convenience of RF data exchange technology is useful in such an environment. Specifically, prior to the performance, the sound engineer ascertains the unique identifier number of each particular controller device to be used in the performance; such unique ID numbers are assigned to each controller device at the time of manufacture. If the sound engineer does not already have the ID number of a given device, he can read this number with a RFID transceiver, which is configured to interrogate a controller device, each of which has an embedded RFID tag (see, FIG. 9) that is configured to return this unique ID number upon interrogation.

Once the sound engineer has this number, it is input into the configuration device, the memory of which contains a database of records for controller devices (see, FIG. 17). Thereafter, configuration updates can be sent from the configuration device by means of RF transmission to the controller device, specifically, with each transmission having an information header in digital form that contains the unique identification number that identifies the particular controller device for which the configuration parameters are intended.

For example, referring again to FIG. 12A, assume that a sound engineer wishes to configure one of the three depicted controller devices 123-125. He transmits a scene record (see scenes database in FIG. 17, discussed below) via RF transmission from the mixing board 121. Each of the three controller devices 123-125 is capable of receiving this given RF transmission; however, the transmission data includes, a header segment that precedes the scene record information. As depicted, the device ID for one of the controller units is “3”, 123. Thus, if the RF transmission is preceded with this unique ID number, two of the controller units 124-125 will ignore the transmission, while the other controller unit 123 will receive it such that its current configuration settings are updated accordingly. In this way, a wireless communication technology that is non-line-of-sight can be employed to configure a single unit in an environment that includes several other units without unintended alteration of data in these other units.

FIG. 12B provides an example of a data transmission by the configuration device 121 depicted in FIG. 12A, including the unique ID number of the controller device for which the transmission is intended (“98593408” in the depicted example).

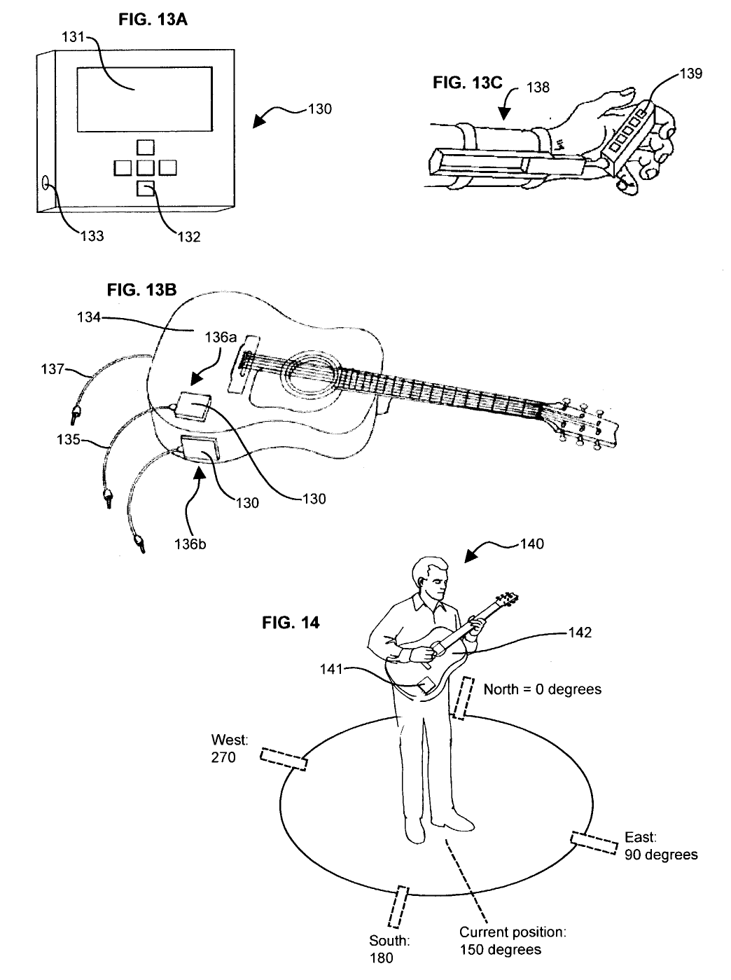

FIG. 13A depicts an alternative controller unit 130 that does not rely upon wireless data transmission or an external configuration device. This unit 130 includes a flat-panel display 131, several keys 132 for manual input of data, and a standard quarter-inch jack 133 for use with a patch chord in communicating control data to an external signal processor. In the simplest embodiment, the keys 132 include a “set maximum” and “set minimum” button, “increase” and “decrease” buttons for the sensitivity threshold, and a “mute” button, which defeats the output of any information by the controller.

FIG. 13B depicts an acoustic/electric guitar 134 upon which have been mounted two controller units 130 such as that depicted in FIG. 13A. As demonstrated, a controller unit can be mounted to the face of the guitar 136a or to the underside of the guitar 136b. Also depicted are patch cords 135 to carry an electric signal from the controller units 130 to the signal processor and a patch cord 137 to carry the electric signal picked up by the guitar's conventional pickups (not visible in this FIGURE) to the signal processor.

FIG. 13C depicts a key palette configuration device 138 that includes several buttons 139 that can be activated by the user's thumb.

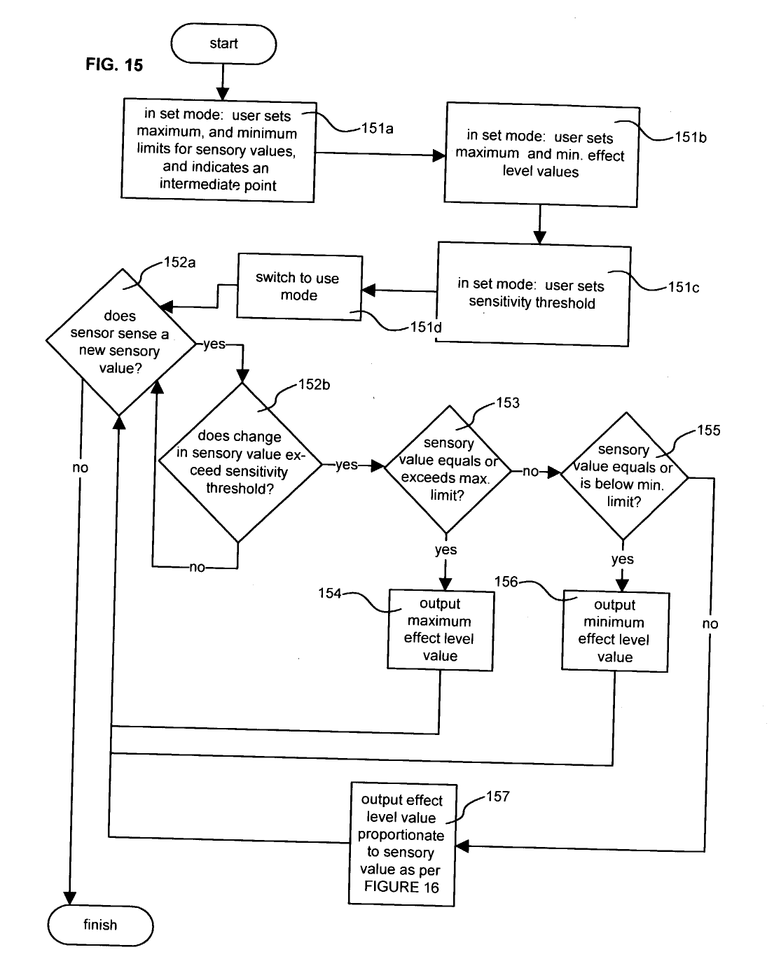

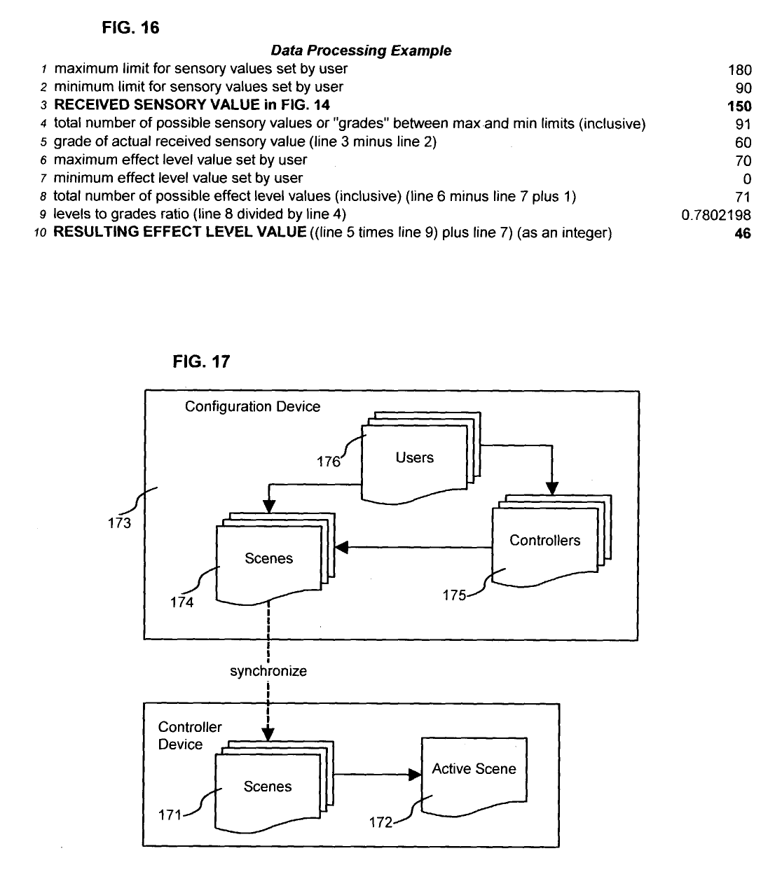

FIG. 14 depicts a musician 140 handling a guitar 142 upon which has been mounted a wireless controller unit 141 such as that depicted in FIG. 10. The environmental sensor included in this unit 141 is a digital compass. As depicted, the compass detects the direction which the guitar 142 and controller unit 141 are currently facing, this direction being compass degree “150” out of a possible three-hundred-sixty compass degrees, wherein north is at zero degrees, east is at ninety degrees, and so on.

This sensory value information as detected by the compass may be processed according to the process depicted in FIG. 15 so as to translate sensory value information into effect level information. The same basic process is used regardless of what environmental sensor is incorporated into the controller device. First, the user switches the unit to “set” mode and, using either the interface included directly in the controller device or an external configuration device, the user holds the guitar in a particular orientation, such as due north, and indicates that that particular position is the maximum sensory value limit 151a. The user then holds the guitar in a different spatial orientation, such as due east, and inputs that this second position represents the minimum sensory value point 151a. He also holds the instrument in a third position and inputs that this third position is between the maximum and minimum 151a; such indication of an intermediate sensory value is necessary in the case of a compass, because compass values fall in an unbroken circle, such that due north and due east are both ninety degrees away from each other and two-hundred-seventy degrees away from each other; the intermediate sensory value eliminates this uncertainty.

He then inputs maximum and minimum effect level values that correspond to the maximum and minimum sensory values 151b. He then inputs a “sensitivity threshold” value 151c. This sensitivity value is used in data processing such that only changes in received sensory values that exceed a certain magnitude result in an output of a new effect level value; smaller changes are ignored.

Then he switches the unit to “use” mode 151d. When in use mode, each time the sensor detects a sensory value that differs from the last sensory value used to produce an effect level value by a margin greater than the user-defined sensitivity threshold value, a new effect level value is produced for output to the signal effects processor. Thus first the threshold is applied and insignificant changes are ignored 152b. Then, when a change is significant enough to exceed the threshold, a comparison is made between the new sensory value and the user-defined sensory value maximum limit for 153. If the new sensory value meets or exceeds the user-defined maximum limit for sensory values, the maximum effect level value is output by the unit 154. If not, the new sensory value is compared to the user-defined minimum limit for sensory values 155. If the new sensory value meets or falls below the minimum limit, the controller unit outputs the user-defined minimum effect level value to the signal processor 156.

If the new sensory value does not fall at or beyond the user-defined limits, an effect level value that corresponds to the received sensory value is output to the signal processor 157.

FIG. 16 depicts the conversion of the sensory value being detected in FIG. 14 to an effect level value for output to a signal effects processor. For the purposes of FIG. 16, it is assumed that the user-defined sensitivity threshold is a change of one compass degree and that an intermediate value between ninety and one-hundred-eighty has been input by the user. The number of steps or “grades” between the user-defined max. and min. sensory values (inclusive) is calculated. The total number of possible effect level values, given the user-defined max. and min. effect level values, is also calculated. A ratio of possible effect level values to grades is found, and then the grade into which the currently sensed sensory value falls (sensed value minus min.) is multiplied by this ratio. The result is added to the minimum effect level value to produce an effect level value that corresponds to the currently sensed sensory value. This corresponding effect level value is then output to the signal processor.

The size of a step between grades can alternately be the size of the user-defined sensitivity threshold.

FIG. 17 depicts the basic database structure that makes easy storage, recall, transmission, and manipulation of configuration information possible.

Each set of user-defined configuration settings (max., min., sensitivity threshold, mapping routine, etc.) is called a “scene”, and each scene is stored as a single scene profile record in a scenes database 171. At any given time, a single scene record is selected as the active scene 172, i.e., the configuration settings to be used when the controller device is in “use” mode. A user can switch between scenes, using either an external configuration device 173 or the self-contained user interface of the controller device itself, in real-time without having to switch the controller device into “set” mode. Thus, this switching can occur rapidly enough to be effectively accomplished during a performance.

If an external configuration device 173 is used, the memory of this configuration device typically contains three databases, namely, a scenes database 174, a controllers database 175, and a users database 176. The scenes database 174 can be synchronized with the scenes database 171 in the memory of the controller device 170. The controllers database 175 includes a record for each controller device that the given user needs to configure, specifically, the unique identification numbers associated with each controller device that are used in data transmission such as that depicted in FIG. 12A. The users database 176 includes a different record for each musician whose controller devices or scenes are to be configured using the configuration device 173. A field in the users database 176 is used in a relational database relationship with a field in the scenes database 174 so that certain scenes can be associated with the musician who uses them. Relationships may also be established between musician and/or scene records and controller records.

When a transmission is made from a configuration device to a controller device during performance, as depicted in FIG. 12B, for instance, this transmission can take the form of a command designating a different scene in the scenes database 174 as the active scene 172.

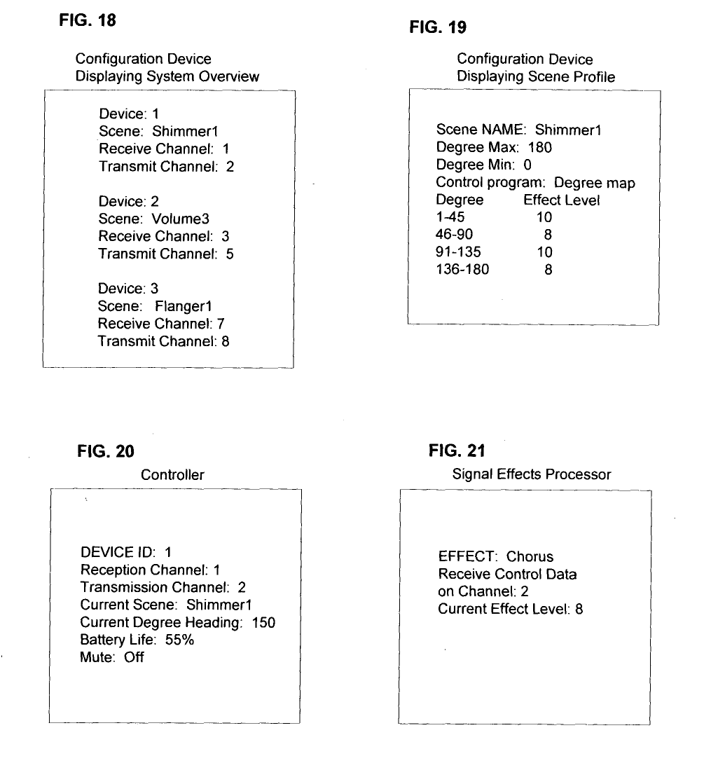

FIG. 18 depicts a screenshot of the visual output of a flat-panel display included in the configuration device. As can be seen, three different controllers are currently being monitored and controlled by the configuration device and general information is provided regarding the scenes currently selected as the active scene for each device, as well as the transmission channels through which each controller's information is transmitted. Transmission channels can either be actual different radio frequencies, which is useful for finding an uncluttered frequency in the given environment, or can be “virtual channels” that are simply provided in the header information of a data transmission.

FIG. 19 depicts a view of a particular scene profile record stored in the scenes database of the configuration device. Here, the fields of the given record pertaining to the given scene as well as the variable content of those fields can be viewed and modified. The depicted scene provides a different mode of data processing than that depicted in FIG. 16. In FIG. 19, a “degree map” has been selected by the user such that, instead of intermediate values being processed as a proportion, intermediate values are simply mapped directly to effect level values. For instance, as shown, in the depicted scene, any sensory value falling between one and forty-five results in an effect level value of ten; any sensory value between forty-six and ninety results in an effect level value of eight.

FIG. 20 depicts a screenshot of the visual output of a flat-panel display included in the controller device while it is in use mode. FIG. 21 depicts a screenshot of the visual output of a flat-panel display included in the signal effects processor unit to which control data is being conveyed from the controller device.

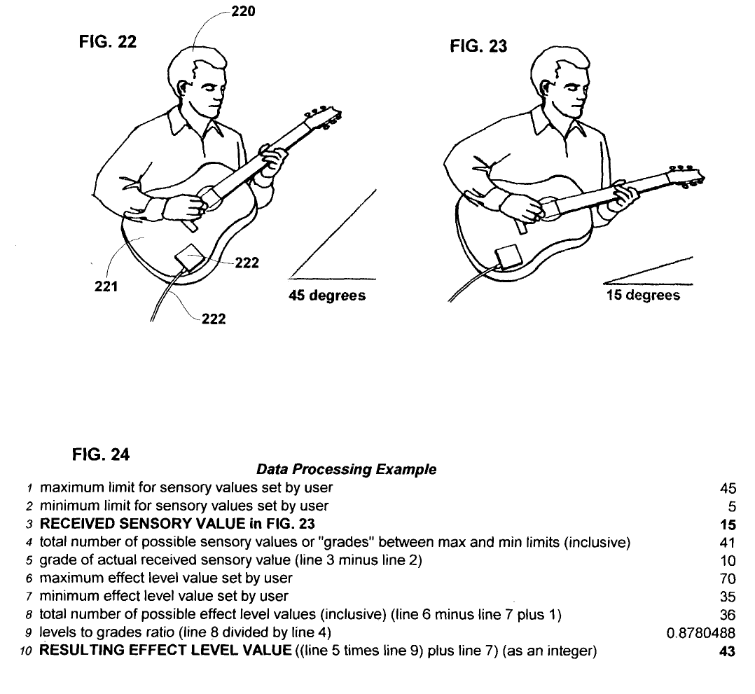

FIGS. 22 and 23 depict a musician 220 with a guitar 221 to which is attached a controller device 222 that includes a tilt sensor as the environmental sensor. In FIG. 22, the guitar 221 is held in a position such that the tilt sensor senses a tilt value of forty-five degrees (relative to a sensible horizon considered to be zero degrees). In FIG. 23, the guitar 221 is held in a position such that the tilt sensor senses a tilt value of fifteen degrees.

FIG. 24 depicts an example of how the sensory value detected by the controller unit in FIG. 23 is converted to an effect level value for output to a signal processor. Here it is assumed that the user sets a sensitivity threshold of one degree.

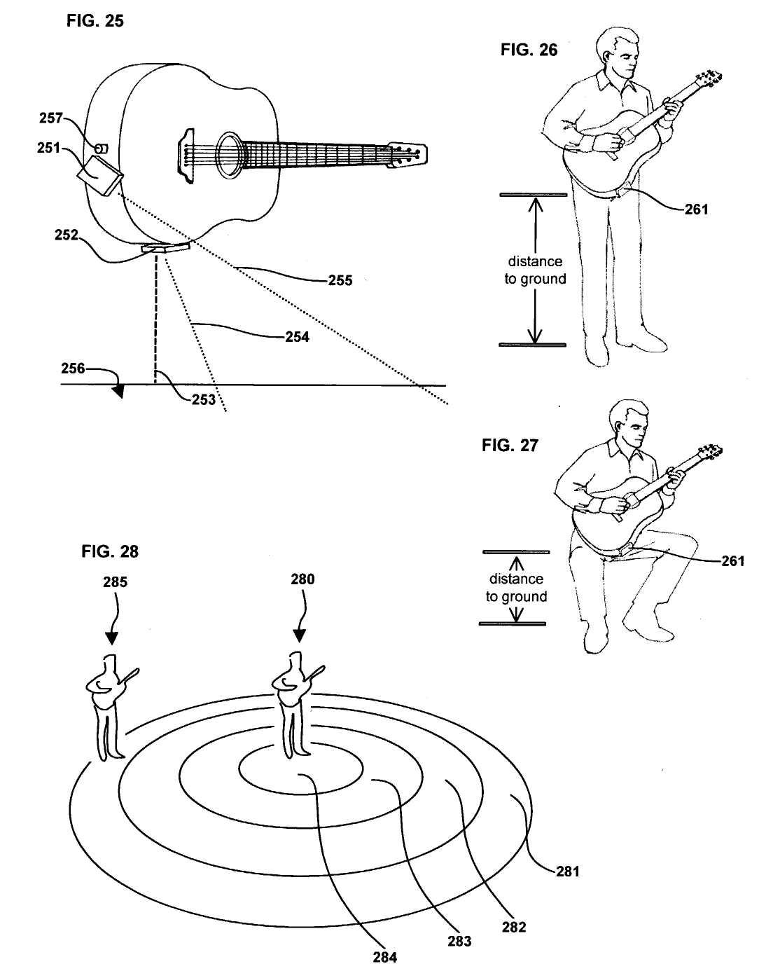

FIG. 25 depicts a perspective view of a guitar upon which have been mounted a controller device 251 equipped with a laser-enabled digital distance meter as the environmental sensor. An alternative is also depicted in which the controller device 252 is built into the bottom portion of the guitar 250. Alternately, another distance measuring system can be used. The line 255 between the controller device 251 and the floor 256 is measured. Ideally, the controller device 251 is positioned so that the laser used in distance measuring is aimed away from the legs of the user to some point on the floor out in front of the face of the guitar. A socket/peg 257 equipped both to serve as a guitar-strap attachment peg and socket for a patch cord to carry a line signal from the guitar's pickups is also shown.

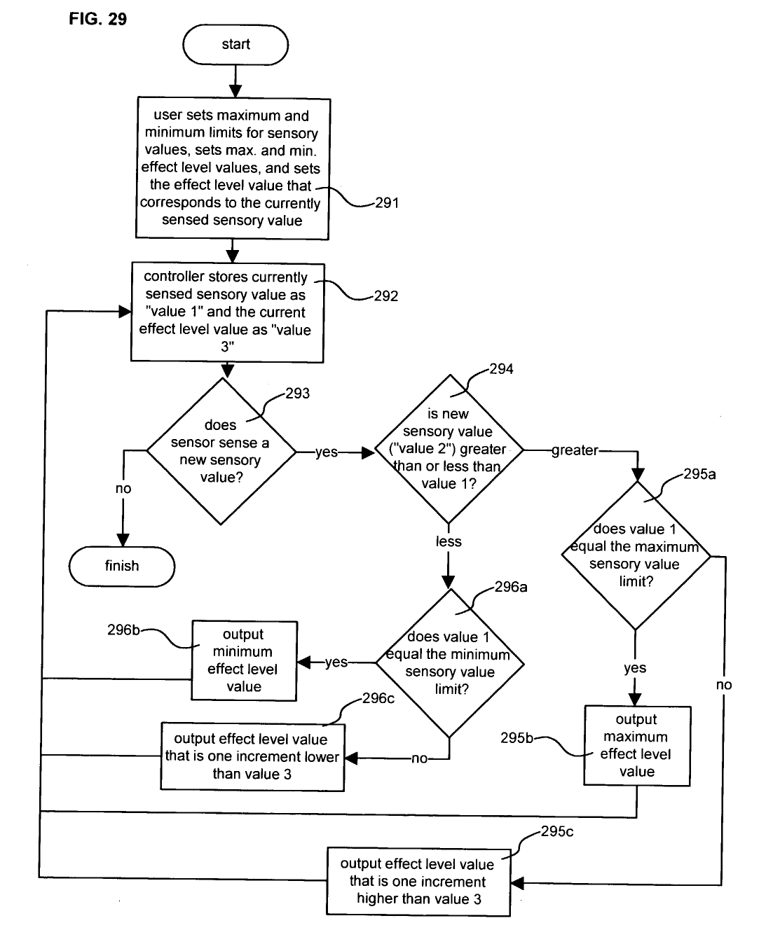

FIG. 26 depicts a guitar player with a guitar upon which has been mounted a controller device 261 equipped with a distance meter. FIG. 27 depicts the same guitar player squatting so that the distance between the controller device 261 and the floor or ground is shorter as shown. Measured distance values are converted to effect level values, and an example of the process used in such a conversion appears in FIG. 29.

FIG. 28 depicts a guitar player holding a guitar equipped with a controller device that includes a GPS receiver as the environmental sensor. When the guitarist is standing in a position 280 that he wishes to serve as the focus, he inputs the current position as the maximum limit for sensory values. The GPS receiver indicates the x and y coordinates (latitude and longitude) in that position 280, and these coordinates are stored in the memory of the controller device. The user then moves to a position 285 some distance away from the focus position 280 and inputs the current position as the minimum limit for sensory values, which is also stored. He then inputs the desired number of gradations between the maximum and minimum limits. Thus, if the user indicates that exactly four gradations are desired, the sensory area will be divided into four concentric circles that delineate four different areas, the focus area 284, the second area 283, the third area 282, and the exterior area 281.

In this GPS-enabled embodiment, the four areas are directly mapped to four different signal processing outcomes. For instance, whenever the GPS receiver indicates that the controller device is within the first area 284, thereby indicating that the user is standing at or near focus position 280, the user-defined maximum effect level value is output. Thereafter, if the user moves to a position 285 that lies within the exterior area 281, the user-defined minimum effect level value is output. Optionally, configuration parameters can also be set such that if the controller moves to a position that lies outside of the limit of the exterior area 281, an effect level value of “zero” is output, thereby essentially turning off the given effect being controlled by the controller, e.g., turning the volume all the way off.

FIG. 29 depicts an alternative process to be used in converting sensory values to effect level values. In the depicted process, changes in sensory value cause relative, incremental, stepwise changes in effect level values rather than directly proportional changes or directly mapped outcomes. First, the user sets maximum and minimum limits for sensory and effect level values, and establishes a correspondence between a certain effect level value and the currently sensed sensory value 291. The starting sensory value is stored as “value 1”, and the starting effect level value is stored as “value 3”. Whenever the environmental sensor senses a new sensory value 293, this new value, “value 2”, is compared to “value 1” 294. If greater, but less than the user-defined maximum sensory value limit, the controller device outputs a new effect level value that exceeds “value 3” by exactly one incremental unit 295c. If the new sensory value meets or exceeds the user-defined maximum sensory value limit 295a, then the controller device outputs the user-defined maximum effect level value 295b.

If the new sensory value is less than “value 1”, but greater than the user-defined minimum sensory value limit 296a, the controller device outputs a new effect level value that is exactly one incremental unit lower than “value 3” 296c. Otherwise, the user-defined minimum effect level value is output 296b. “Value 2” is then stored as “value 3” for comparison to whatever the next new sensory value received shall be 292. Meanwhile, the newly output effect level value is stored as the new “value 1” so that the process can be repeated upon receipt of new sensory data.

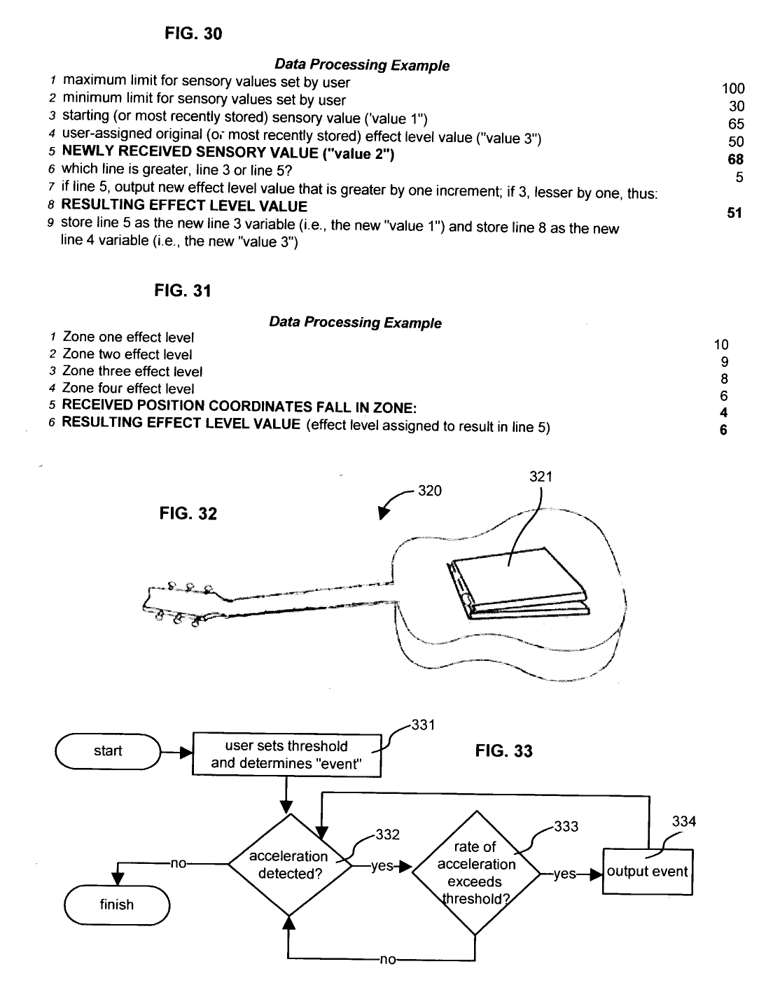

FIG. 30 depicts an example of a sensory value being converted to a signal effects level value according to the process depicted in FIG. 29.

FIG. 31 depicts an example of a sensory value being converted to a signal effects level value according to the zone mapping described in reference to FIG. 28.

FIG. 32 depicts the back of an acoustic/electric guitar 320. A controller device equipped with a digital weight/pressure scale 321 is affixed to the back of the guitar such that, when the guitar is pressed against the abdomen of a user during performance, this pressure is sensed by the scale 321. As with other embodiments, the user sets maximum and minimum limits for received sensory values, e.g., ounces, and the other configuration settings for conversion of weight/pressure units to signal effect level values.

FIG. 33 depicts the process by which an instrument-mounted controller equipped with an accelerometer can be used to trigger events. First, the user sets an acceleration threshold and an event to be triggered when this threshold is exceeded 331. Then, when the instrument is moved so that the accelerometer detects a value that exceeds the user-defined threshold, the event is triggered 334.

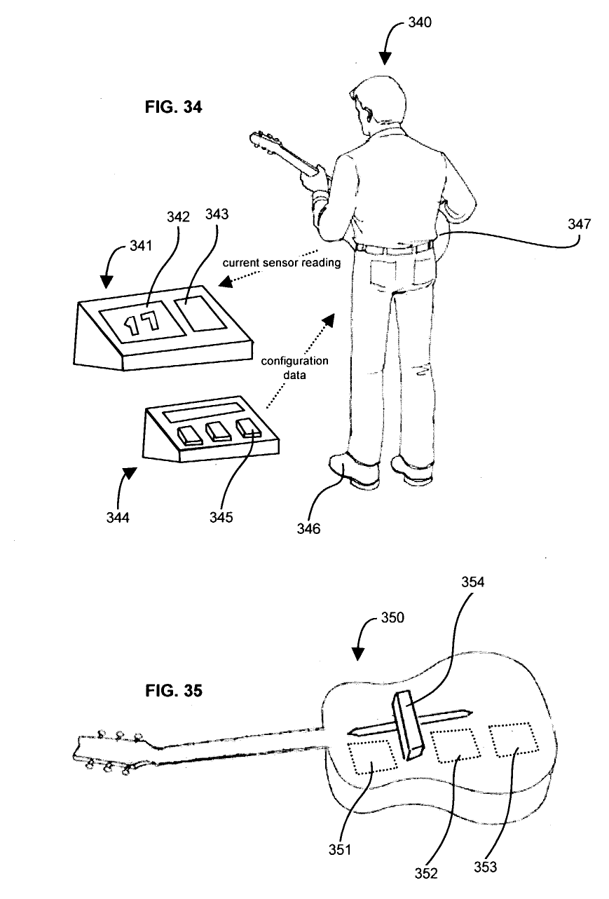

FIG. 34 depicts a guitarist 340 playing a guitar 347 equipped with one or more of the controller devices depicted elsewhere herein. A footpedal board 344 with multiple footpedals 345 serves as the configuration device. Configuration settings are input by the user 340 using the footpedals 345, and these settings are wirelessly transmitted to the controller device mounted on or within the guitar 347. Meanwhile, the current sensory value being sensed by the controller device is wirelessly transmitted to the floor monitor 341 to be visually displayed by flat-panel display 342. Like typical floor monitors, the depicted monitor 341 also includes an audio speaker 343.

FIG. 35 depicts the back of an acoustic/electric guitar 350. Mounted thereon is a fader 354 similar to the faders used on a common mixing board. The fader 354 is positioned for making contact with the abdomen of a guitar player during performance. By pushing the guitar 350 side to side while holding such a fader 354 in place by holding it against his abdomen, a guitar player can directly control a signal level or signal effect level. Also mounted within the guitar 350 are: a controller device equipped with a digital compass 351, a controller device equipped with a tilt sensor 352, and a controller device equipped with a GPS receiver 353. By mounting multiple controllers in or on a guitar, multiple variables can be directly controlled simultaneously, and combinations of sensory data can be used as described below.

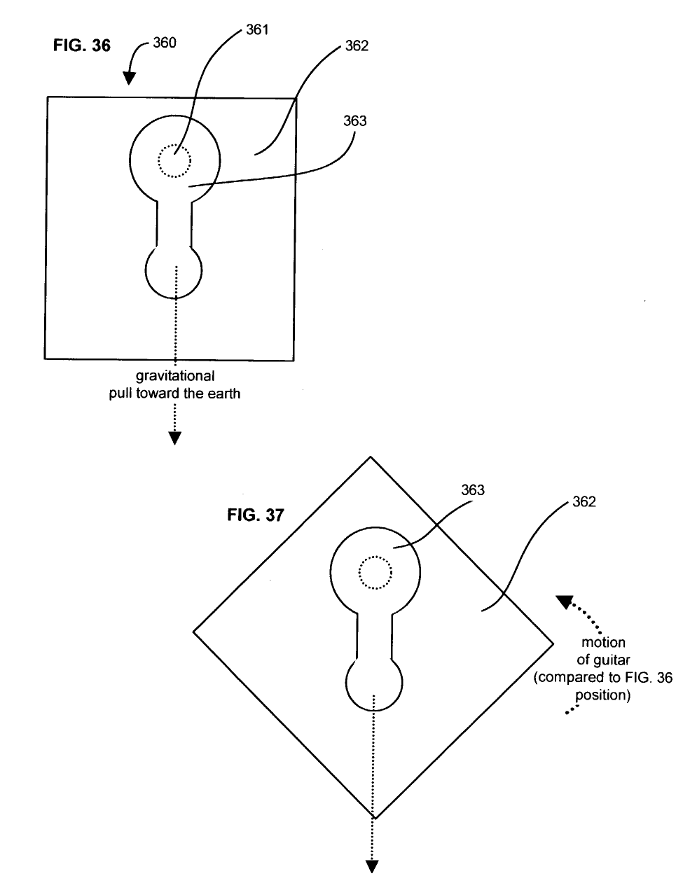

FIG. 36 depicts a low-tech alternative mechanism by which a variable may be controlled by tilting the musical instrument. In this case a pendulum 363 is removably attached to a volume control knob 361 that appears on the front of a guitar 360 (for simplicity, only a portion 362 of the guitar 360 is depicted in FIGS. 36 and 37). When the guitar 360 is tilted as in FIG. 37, gravity holds the pendulum 363 and thus the volume control knob 361 in place, thus creating turning of the knob relative to the guitar.

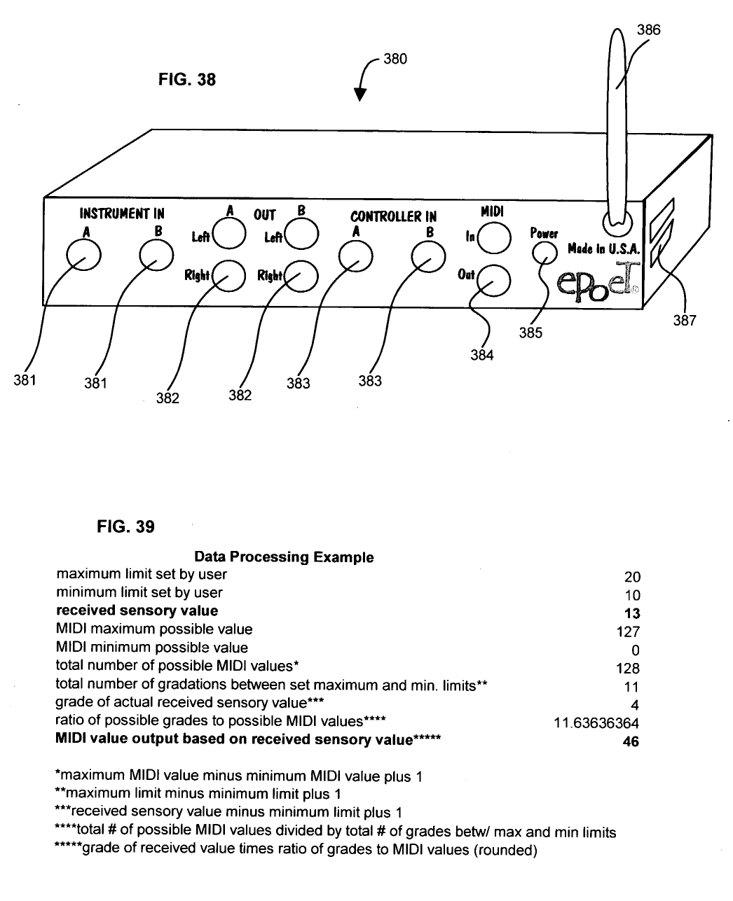

FIG. 38 depicts a perspective view of the posterior of a signal effects processor according to the present invention. Included therein are two sockets 381 for receiving a line signal from an instrument such as an electric guitar. So that stereo output is possible, two pairs of left and right line out sockets 382 are included, one pair for each instrument line signal in. Two sockets 383 for receiving signal effects level values from a controller device by patch cord are also included. MIDI in and MIDI out ports 384 and a socket for the power supply 385 also appear. An antenna 386 for receipt of effect level values transmitted wirelessly appears, as do two USB ports 387. Alternately, an external, stand-alone wireless transmission/reception system, e.g., Nady, can be plugged into the appropriate socket.

It should be noted that all the devices used herein to sense and convert sensory values to effects level values can alternately be used to output MIDI values instead. In particular, the present invention is well-suited to control MIDI parameters using a MIDI guitar equipped with one of the above disclosed controller devices. In such a case, the guitar is used to produce MIDI note information and the controller to produce MIDI parameter information. The compass-enabled embodiment is particularly appropriate and intuitive as a controller for stereo panning: turn left to pan left, turn right to pan right. A data processing example in which a sensory value is converted to a MIDI parameter value appears in FIG. 39.

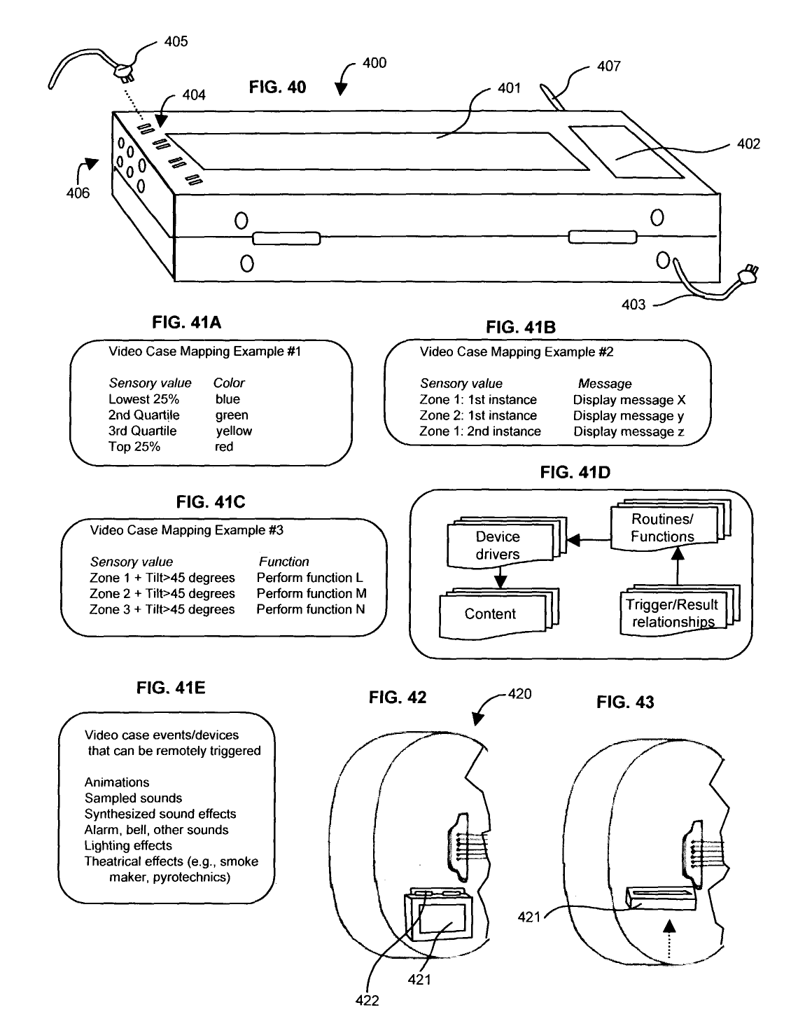

FIG. 40 depicts a guitar case 400 (hereinafter, a “stageshow case”) equipped with a video display 401, a patch bay 406, a power strip 404 configured to receive and conduct power to a power cord 405 of an external device (not pictured), a power cord 403 for plugging into a standard (e.g., 110 V) wall outlet, an audio speaker/monitor 402, and an antenna 407 for use in sending and receiving RF transmissions. The case 400 also includes internal components typically appearing in a configuration device, such as that depicted in FIG. 9. In particular, this case 400 is suited to serve as a portable stageshow enhancement for a working musician by receiving sensory data from a controller device and displaying images or performing other functions in response to such data. It is also designed to replace some of the equipment—patchbay, power strip—that a musician typically must bring to a gig. Finally, it includes means for recharging the internal components of a guitar, discussed fully below in reference to the “guitar docking station.”

FIGS. 41A through 41E depict some of the functions to which a stageshow case can be applied. In FIG. 41A, sensory values are mapped to colors such that the video display 401 displays a color corresponding to the currently sensed sensory value.

FIG. 41B depicts a more complex example of mapping: here, the first time the sensory value associated with “zone 1” in a GPS-enabled controller device is output, a message “X” is displayed; the second time this “zone 1” sensory value is detected, i.e., after intermediate detection of a non-“zone 1” value, a message “Z” is displayed.

FIG. 41C depicts another more complex example of mapping: here, combinations of unrelated sensory data are used to control additional variables. For instance, whenever both “zone 1” is output by a GPS-enabled controller and a tilt value in excess of “45 degrees” is output by a tilt sensor-enabled controller simultaneously, the stageshow case 400 performs “function L”, which could be a sound effect, lighting effect or any other function such as those depicted in FIG. 41E.

The databases stored in the memory of the stageshow case for use in performing the functions described are depicted in FIG. 41D, including user-defined relationships of triggering events and results; routines associated with results; software drivers for driving devices like the video monitor or a sound effects generator; and content, such as video animations.

FIG. 42 depicts a guitar upon which is mounted a video monitor 421 that is mounted upon hinges 422 so that this display 421 can be turned to face up as depicted in FIG. 43. A guitar player playing the depicted guitar 420 can read this display 421 simply by looking down. Such a monitor, configured to receive transmissions from the stageshow case, allows a guitarist to know what is being displayed via the stageshow case at all times, even when it is not directly visible to him.

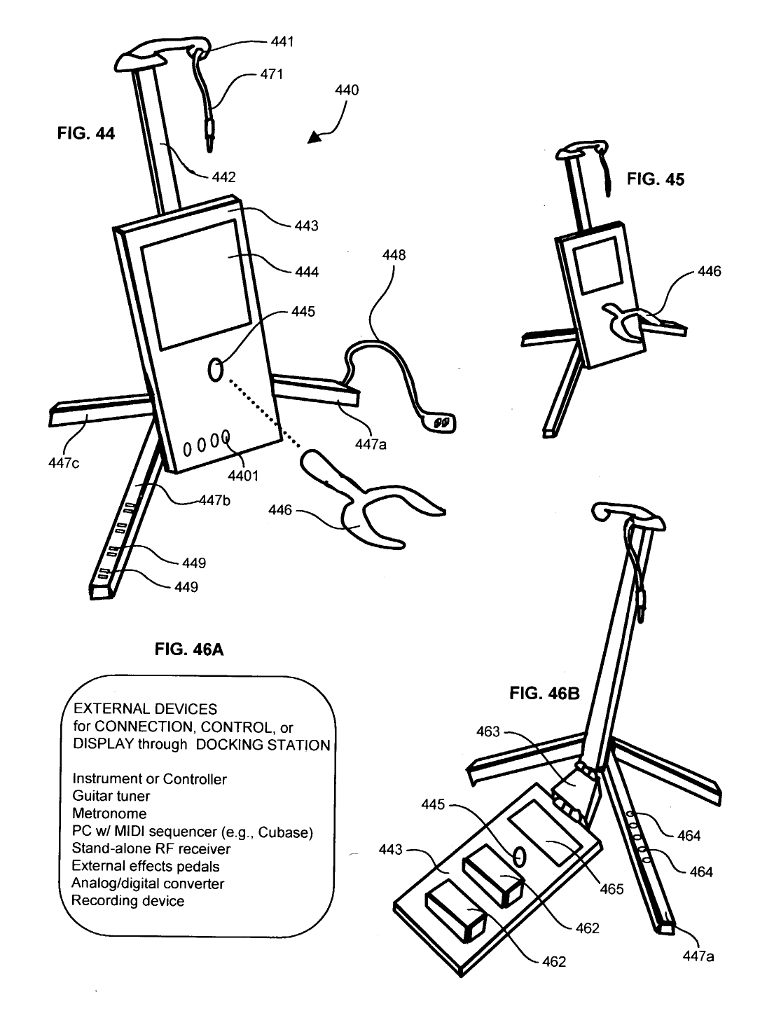

The guitar-mounted or guitar-embedded controller devices disclosed herein may alternatively be powered by rechargeable batteries. To facilitate the use of such reusables, a guitar “docking station” 440 is disclosed in FIG. 44. As with conventional guitar stands, the guitar docking station 440 provides a rigid holder 441 suited for receiving the neck of a guitar. This holder is supported by a rigid shaft 442 that includes an antenna for use in wireless transmission to and from an electronic data-processing device 443 that includes a flat-panel display 444. The shaft 442 also contains a power cord for use in docking to a guitar as described below. A socket 445 pierces the body of the device housing 443 so as to accommodate a conventional second rigid holder 446 suited for supporting the body of a guitar. Several data ports 4401 also appear for transfer of digital and/or analog information into and out of the data-processing device 443. Unlike conventional guitar stands, the guitar docking station provides a power cord 448 suited for plugging into a typical wall outlet such as a 110 V socket. Bringing power into the guitar stand itself enables a variety of advantages. Power is run by internal cable through one leg 447a to a second leg 447b and then distributed through several conventional power outlets 449 so that this second leg 447b serves as a power strip that the musician can use to power amplifiers, mixers, etc.

FIG. 45 depicts the guitar docking station once the second rigid holder 446 has been put into the socket 445 so as to accommodate a guitar.

FIG. 46A depicts a chart of some of the devices which can be connected for data exchange with the guitar docking station by way of the included data ports 4401.

FIG. 46B depicts the guitar docking station once the electronic device housing 443 has been folded down to rest on the floor by function of a hinged connector 463 that connects the housing 443 to the remainder of the guitar docking station 440. When the housing 443 has been so deployed, two footpedals 462 for input of information by the musician are revealed, as well a video display 465.

FIG. 47 depicts a closer view of a portion of an embodiment of the guitar docking station. In this embodiment, a power cord 471 configured to carry electricity from the remainder of the guitar docking station up through the shaft 442 and through the upper rigid holder 441 appears. The end of this cord 471 provides a jack 472 suitable for plugging into a guitar as described below.

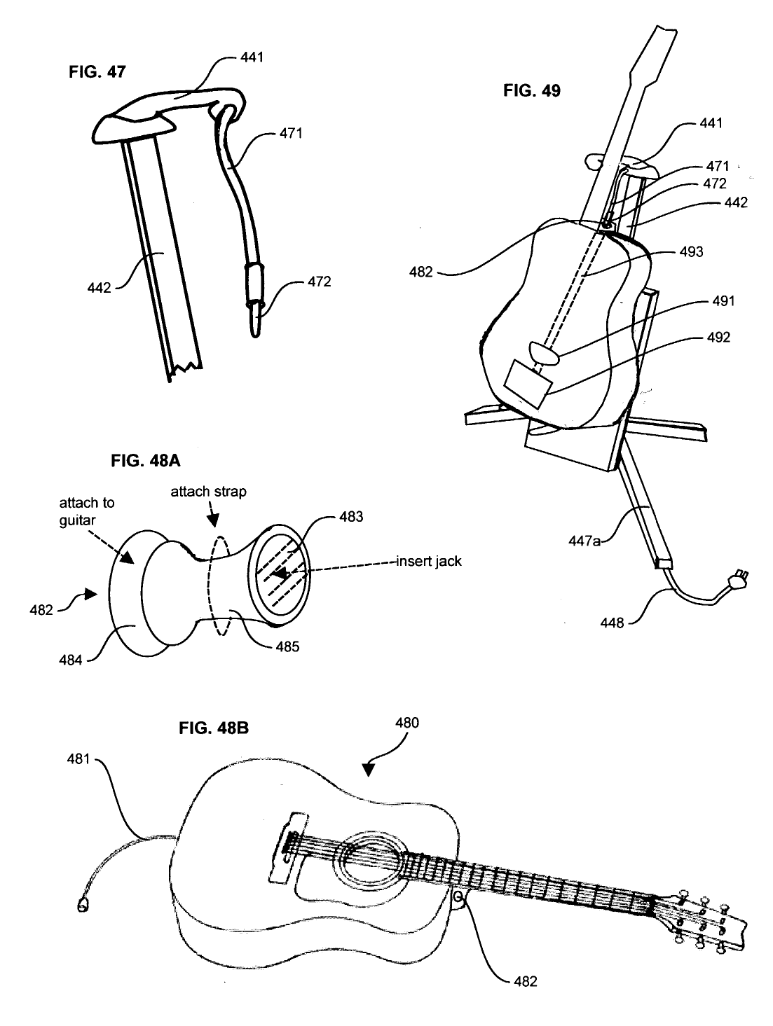

FIG. 48A depicts a socket/peg 482 equipped both to serve as a guitar-strap attachment peg and as a socket to receive the power jack 472 of the guitar docking station. The jack 472 is inserted into the socket 483, while a strap may be attached to the stem 485 of the peg 482. The base 485 is mounted on the guitar itself as depicted in FIG. 48B.

FIG. 48B depicts the guitar 480. Conventional acoustic/electric guitars provide that the electrical signal picked up by the guitar's pickups is output through a patch cable 481 inserted into a peg that also serves as a guitar strap attachment mechanism. This socket/peg typically appears at the base of the guitar as shown in FIG. 25. In the present invention, power is conducted through the other socket/peg 482 from a guitar docking station 440 to the relevant components of the guitar 480 (see below) so as to recharge the batteries thereof.

FIG. 49 depicts a guitar in the guitar docking station. The jack 472 of the power cord 471 of the docking station has been plugged into the socket/peg 482 of the guitar so that power is carried by internal conductor wire 493 to the active pickup 491 and controller device 492; these components can thus be recharged when the guitar docking station wall outlet cord 448 has been plugged into a wall outlet.

So as to facilitate the integration of the devices disclosed above into the broader landscape of music, a universal music exchange medium (hereinafter, “UMEM”) has been developed. Combining disparate elements such as (i) techniques used in markup languages (e.g., HTML, XML, MML), (ii) optical scanning technologies (e.g., bar codes), and (iii) the “parameter” approach used in MIDI, the UMEM allows data pertaining to almost the entire scope of a musical performance—the musicians, the compositions, the technology, the law—to be freely exchanged in a single common format. The physical objects that can serve to carry UMEM information range from sheet music to personal ID cards for musicians to the instruments themselves. Information transferred by way of the UMEM can be imported or exported from virtually any data processing device or simply printed in human-readable form.

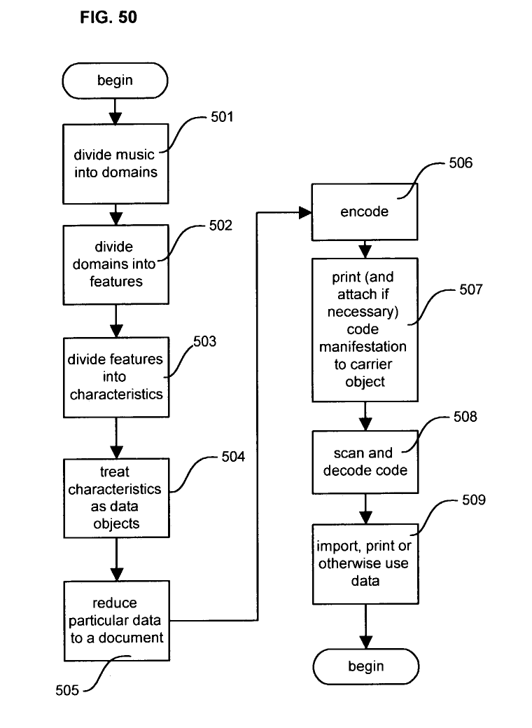

FIG. 50 depicts the basic process by which information is handled under the UMEM. First, substantially all aspects of a music performance are broken down into domains 501. Domains are subdivided into features 502, which features are in turn subdivided into characteristics 503. Each characteristic is treated as a data object 504, and can be further subdivided as necessary to handle more detailed information.

A text document is then created in which data pertaining to and describing a particular set of domains, features, and characteristics is recorded in a form that shows this data structure by way of tags similar to those used in a typical markup language 505. This document is then encoded using 2D encoding or other high-density optically scannable coding technology 506. A visual, physical manifestation of this code is then printed and attached to or printed directly on a physical object, such as a piece of sheet music, a diskette, a compressor/limiter, a pair of headphones, an instrument, a microphone, an ID card, etc., 507. The code is then at some later time scanned and decoded 508. Decoding can be accomplished by the same device or by some other device than that which includes the scanner. The decoded information is then imported directly into a database configured to access the data contained in each node of the document per the UMEM data structure as manifested in the document, edited with text editor software, printed for human reading, or otherwise accessed, manipulated, distributed, or utilized 509.

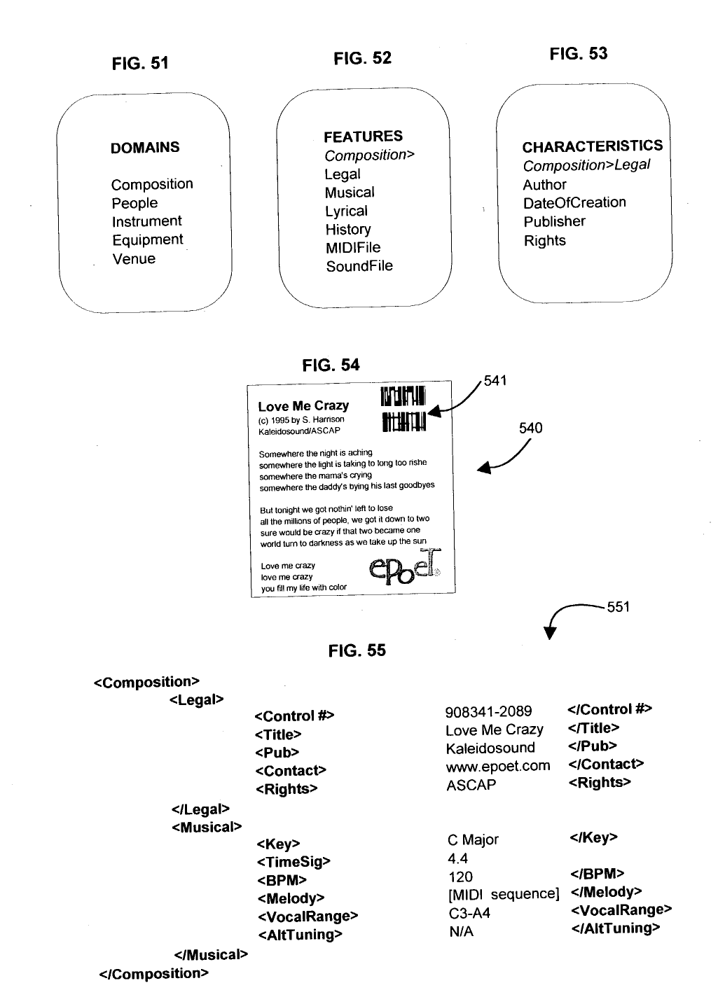

FIG. 51 depicts a chart of example domains into which a musical performance can be separated. FIG. 52 depicts an example breakdown of features into which a particular domain, namely, that of a composition, can be separated.

FIG. 53 depicts example characteristics that can be treated as data objects pertaining to a particular feature of a particular domain, namely, the legal parameters pertaining to a composition, so as to create a structured form document that serves to enable the remainder of the UMEM invention. Every feature should contain at least one data object or be omitted. Identifying these characteristics and underlying data structures and assembling them for use in a single common exchange medium establishes a lingua franca for substantially all the music industry.

FIG. 54 depicts a piece of sheet music 540 upon which has been printed a 2D code 541 in which is encoded a UMEM document, an example excerpt from which document appears in FIG. 55. Note that the example excerpt 551 includes a container field tag (“<Melody>”) that denotes that the following information is not in human readable form but is a MIDI sequence. Thus, certain software applications ignore all data within the “<melody>” node, while other applications, such as a MIDI sequencer configured to import UMEM documents, import the data in the melody node as a standard MIDI file so that it can be played back for a person wishing to learn the depicted composition.

Other information that can be included in the UMEM document to be attached to sheet music includes: recommended scene profile records that can be directly imported into a scenes database in a configuration device, recommended type of sensor for use with the song, audio file samples of famous recordings of the song, guitar tablature, alternate arrangements, etc. In this way, printed sheet music becomes a medium for quick configuration of the controller devices depicted herein as well as rapid dissemination of new controller scenes, MIDI sequences, training materials, etc.

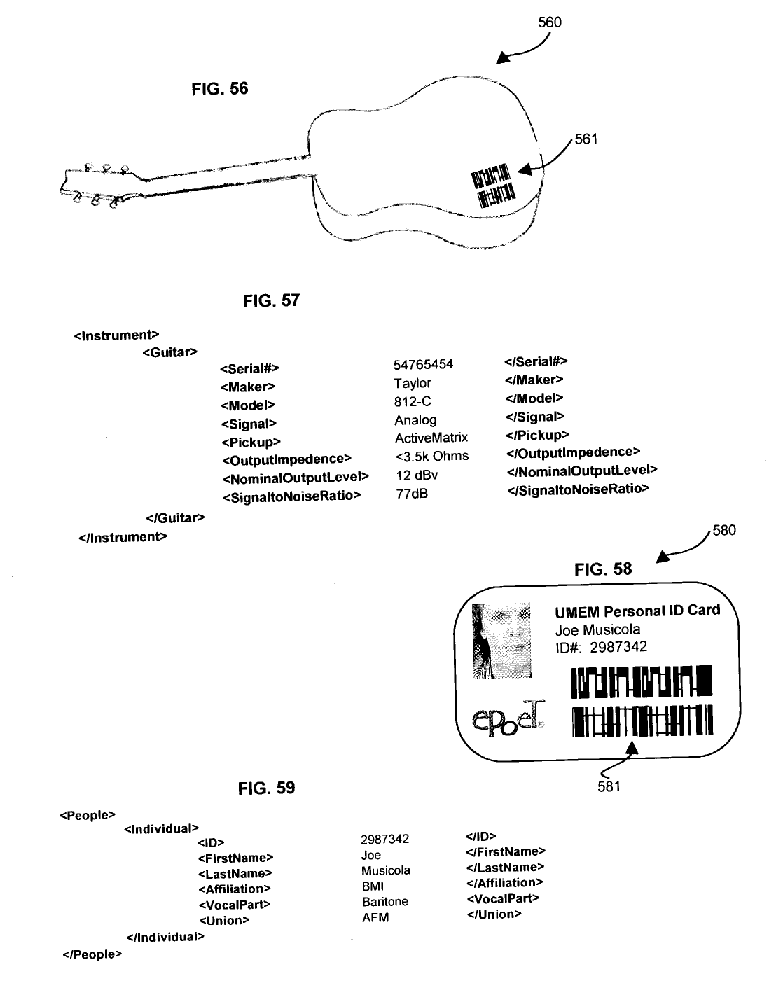

FIG. 56 depicts the back of a guitar 560 upon which has been applied a UMEM code 561. FIG. 57 depicts an example excerpt from the UMEM document encoded in this UMEM code 561, whereby product specifications directly from the manufacturer are made instantly available upon scanning and decoding. No reference to an external database or manual is needed.

FIG. 58 depicts a UMEM personal ID card 580 that includes both basic human-readable text information, such as the musician's name, as well as a UMEM code 581 through which additional information pertaining to the individual, from professional associations to musical aptitudes, can be gained upon scanning and decoding. FIG. 59 depicts an example excerpt from the UMEM document encoded in this UMEM code 581.

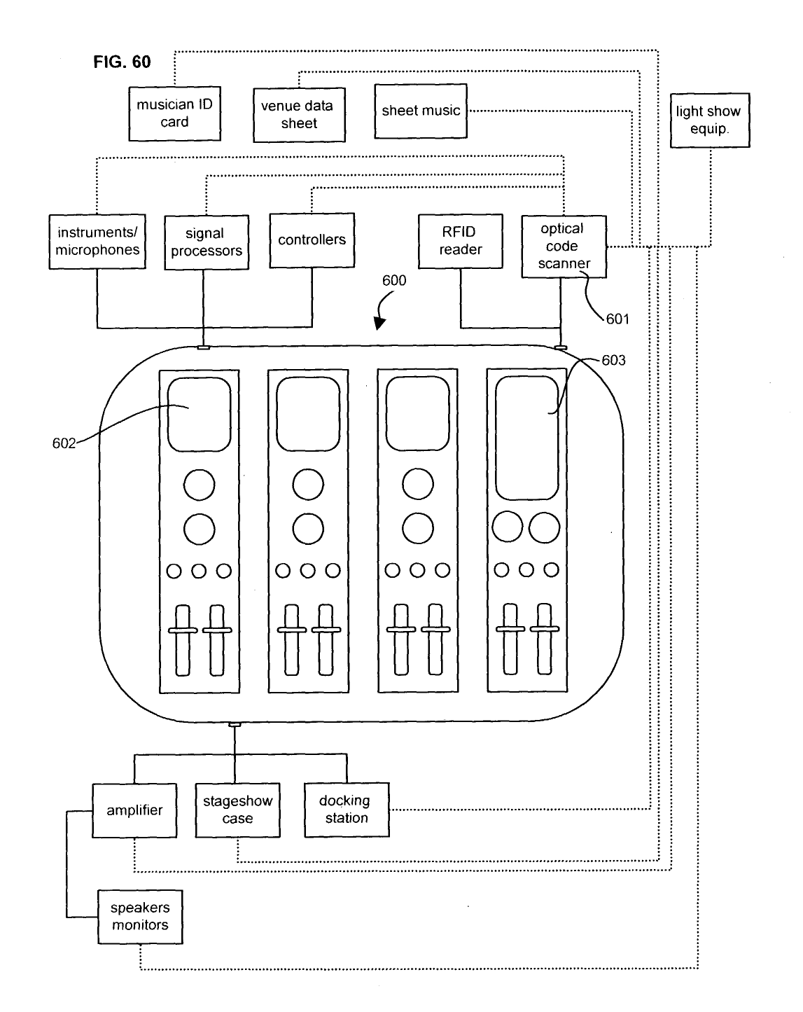

FIG. 60 presents a schematic diagram of the relationship between a configuration device 600 that is a mixing board, similar to the configuration device 121 in FIG. 12A, and a variety of the other devices that form a part of the present system. Data exchange links described earlier between the mixing board 600 and such devices as controllers, signal processors, instruments, P.A. equipment, etc., are present. Additionally, however, the depicted configuration device 600 is also linked to acquire information by way of an external code scanner 601 configured to read 2D UMEM codes. Through this UMEM scanner 601, all manner of specification information regarding the various devices to be used in a musical performance can be input into the configuration device 600 and displayed and manipulated through the touch screen displays 602 associated with each channel in the mixing board 600. Thus, a sound engineer can have the actual specs of the given guitar or microphone being fed into a given channel of the mixing board directly in front of him while mixing. As discussed in more detail below, a large variety of data processing opportunities are made possible by making all this information available in a single structured form to a single configuration device, thereby making the job of a sound engineer much easier to perform. Moreover, by scanning the UMEM codes contained in or on other depicted objects, the sound engineer can also view acquired data pertaining to a wide variety of other factors in the musical performance, including factors which are typically not under the control of the mixing board, such as information pertaining to the musicians performing, the compositions being performed, the venue in which the performance is taking place, and the light show equipment. Access to such information also significantly facilitates effective management of the performance by a sound engineer or other behind-the-scenes personnel. For instance, an engineer can follow along in a song by displaying the lyrics in the master display 603 once the lyrics have been downloaded into the configuration device 600 by way of the UMEM scanner from the sheet music so that he does not miss any cues.

FIG. 61 depicts a schematic diagram of a single, simple, illustrative process by which the unique capabilities of the guitar docking station and the UMEM can be advantageously deployed. A piece of sheet music 610 bearing a UMEM code is scanned using a scanner 611 equipped to decode UMEM codes as well to produce a graphical image file such as a JPEG or GIF file. These files, both the image file and the decoded UMEM document, are transferred to a configuration device 612 such as a handheld or tablet PC. The UMEM document may be imported directly into a database in the configuration device, with data being mapped to fields identified by UMEM tags. Files in the configuration device can be edited, transferred, etc., as needed.

The user transfers the files to the guitar docking station 613, where sheet music image files or the UMEM-derived database record pertaining to the given composition can be viewed via flat-panel display 614. Data from the UMEM document now in the docking station can be used to trigger a metronome at a specified beats-per-minute rate, to play the MIDI sequence from the “<melody>” node in the UMEM-document, etc.

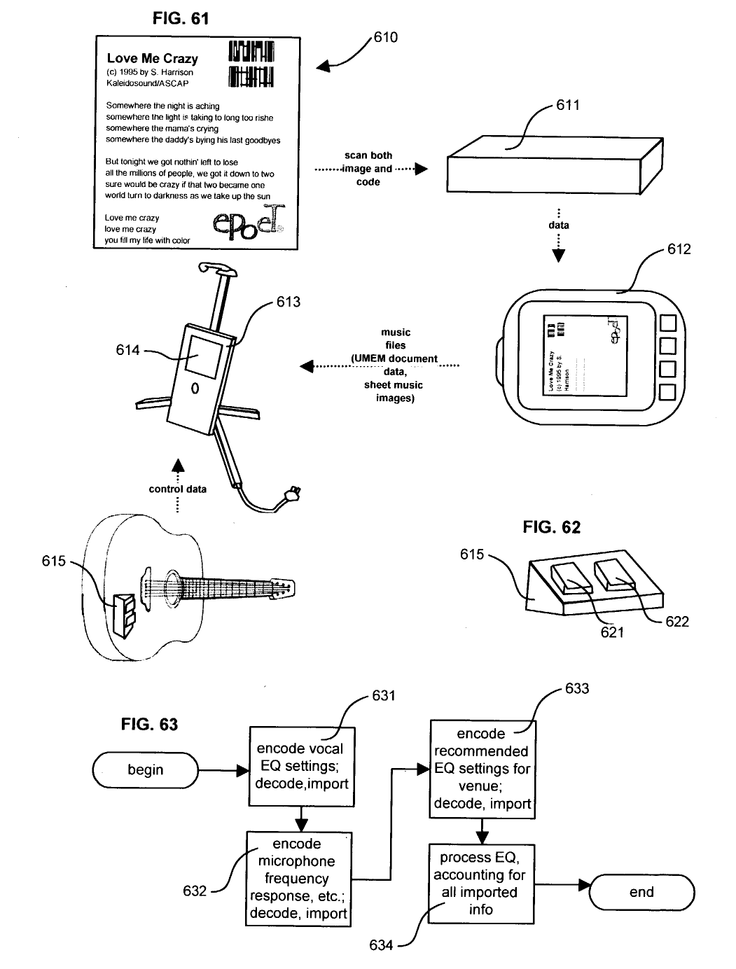

During performance, an instrument-mounted controller 615 equipped with page-turner buttons, including a “last page” button 621 and a “next page” button 622 in FIG. 62, is used to transmit control information to the guitar docking station so that the musician can navigate through the pages of scanned sheet music.

The UMEM makes possible entire new businesses, recording and engineering techniques, forms of publication, and applications of technology. An additional example is illustrative.

For instance, referring to FIG. 63, EQ settings applied to a given singer's voice by a particular engineer during a particular performance are documented in a UMEM document, a code manifestation of this document applied to an identification card for said singer (e.g., FIG. 58), and then this code is instantly recalled later by an engineer using a configuration device with a graphic equalizer configured to import EQ settings under the UMEM 631.

Then, the characteristics of a particular microphone, as published by the manufacturer and manifested in a code applied directly to the microphone itself, are imported into the same device by way of UMEM 632.

Known equalization problems and suggestions associated with a particular venue (concert hall, nightclub, etc.), e.g., a particular sound frequency that tends to feedback in the given venue, are then documented in a UMEM document kept on file at the venue (similar to ID card for individuals) and then imported into the same configuration device via UMEM scanning and decoding of the document 633.

Then the equalization data pertaining to the singer, the venue, and the particular piece of equipment to be used at a particular performance are combined to produce an equalization that is uniquely customized for that particular event 634. Frequency response of the speakers to be used and other characteristics of other equipment can also be factored.

Thus, by use of the UMEM and UMEM-enabled equipment, large amounts of labor and time typically required when each engineer starts from the ground up in equalizing frequencies for a performance are saved with instantaneous recall of structured, encoded, highly portable and durable information.

Eventually, noted engineers, producers, conductors, performers, composers, and other music makers may find a market in serving to produce UMEM documents to be attached to all the instruments, processors, P.A. equipment, printed sheet music, and other marketable goods that are the daily fare of the music industry.

Licensing information may be obtained through www.epoet.com.

1. A method of controlling signal effects comprising the following steps:
mounting a controller device comprising a compass on or in a stringed musical instrument;
sensing a directional degree with said compass;
converting said degree to a signal effect level value; and
adjusting the level of a first signal effect according to said signal effect level value.

2. The method in claim 1 additionally comprising the following step:
transmitting information by way of RF transmission to or from said controller device wherein said information comprises an identifier that uniquely identifies said controller device.

3. The method in claim 1 additionally comprising the following step:
mounting a controller device comprising a GPS receiver on or in said musical instrument.

4. The method in claim 1 wherein said first signal effect is applied to an analog signal generated by a pickup in said musical instrument.

5. The method in claim 4 wherein said first signal effect is distortion, reverb, chorus, overdrive, flange, wah-wah, stereo panning, delay, or volume.

6. The method in claim 1 additionally comprising the following step:
configuring said compass by way of a user interface device, wherein said user interface comprises a touch screen, a manual interface, a foot pedal, a speech recognition interface, or a handwriting recognition interface.

7. The method in claim 6 additionally comprising the following step:
setting a maximum or minimum signal effect level value or a maximum or minimum sensory value using said user interface device.

8. The method in claim 1 additionally comprising the following step:
setting an intermediate value between a maximum and a minimum such that the relationship between said maximum and said minimum becomes more definite.

9. The method in claim 1 additionally comprising at least one of the following steps:
placing said musical instrument in a docking station;
downloading configuration information from a remote computer via the Internet into said controller device;
encoding a document in a code suitable for printing; or
controlling a video monitor mounted in or on an instrument case by transmission of a value.

10. The method in claim 1 additionally comprising the following step:
setting a sensitivity threshold by way of a user interface.

11. The method in claim 1 additionally comprising at least one of the following steps:
pressing a user interface attached to said musical instrument against the abdomen of a first musician;
interrogating an RFID tag; or
scanning a symbol in which is encoded a document containing specifications pertaining to said musical instrument.

12. An apparatus comprising:
a musical instrument;
a means of sensing a position value, said means comprising a compass or a GPS receiver;
a means of converting said position value to a signal effect level value; and
a means of communicating said level value to a signal effects processor.

13. The apparatus in claim 12 additionally comprising means of wirelessly transmitting and/or receiving transmissions that include an identifier that identifies said apparatus.

14. A system comprising:
a stand suitable for holding a stringed musical instrument, such as a guitar, said stand comprising a plurality of support members whereof one of said support members is a first support member and at least one of the following is true:
said first support member comprises a plurality of sockets such that said first support member can serve as a power strip or a patchbay; and/or
said first support member comprises a contact point configured to conduct energy to a rechargeable component within a stringed musical instrument when said contact point is in contact with said stringed musical instrument.

15. The system in claim 14 additionally comprising a stringed musical instrument wherein said musical instrument additionally comprises a rechargeable component.

16. The system in claim 15 wherein said stringed musical instrument additionally comprises an environmental sensor, such as a compass or a tilt sensor.

17. The system in claim 16 additionally comprising at least one of the following:
means for converting sensory data to effect level values;
means for wireless transmission of data;
means for scanning a code;
means for triggering events upon the simultaneous occurrence of two conditions; or
means for movably coupling an electronic device to a guitar.

18. The system in claim 14 additionally comprising a foot-operable user interface.

19. The system in claim 18 additionally comprising a movable coupling between said stand and said foot-operable user interface.

20. The apparatus in claim 12 additionally comprising at least one of the following:
means of displaying an encoded symbol for use in conveying product specification information;
means of conveying information via RFID tag technology; or
means of conveying information via UMEM.
